(19) United States
(12) Patent Application Publication
(10) Pub. No.: US 2015/0130751 A1
(43) Pub. Date: May 14, 2015

(54) DISPLAY DEVICE AND ELECTRONIC APPARATUS

(71) Applicant: Sony Corporation, Tokyo (JP)

(72) Inventor: Shinichi Teraguchi, Kanagawa (JP)

(73) Assignee: Sony Corporation, Tokyo (JP)

(21) Appl. No.: 14/405,268

(22) PCT Filed: Aug. 28, 2013
(86) PCT No.: PCT/JP2013/005089

§ 371 Date: Dec. 3, 2014

(30) Foreign Application Priority Data
Sep. 4, 2012 (JP) 2012-193708

(51) Int. Cl. G06F 3/041; G09G 3/32; G09G 3/36

(52) U.S. Cl. CPC G06F 3/0412; G09G 3/3611; G09G 3/3275; G09G 2300/0426
USPC 345/174; 345/103; 345/80

(57) ABSTRACT

There is provided a display device including a pixel unit (10) including a first substrate (11); a touch sensor unit (30 including a second substrate 23); and a liquid crystal layer (18) formed between the pixel unit (10) and the touch sensor unit (30). The touch sensor unit (30 includes a detection electrode (22) capacitively coupled with a driving electrode (19), both the detection electrode (22) and the driving electrode (19) being formed on a side of the touch sensor unit (30 facing the liquid crystal layer (18).

### TECHNICAL FIELD

The present disclosure relates to a display device having a touch sensor function and an electronic apparatus.

### BACKGROUND ART

Recently, the number of display devices and electronic apparatuses in which a touch sensor function, a 3D display function, and the like are built increases. Generally, in a display device to which such functions are added, substrates (modules) having respective functions are built on a display device, and accordingly, a total substrate thickness of the display device becomes thick. In addition, such a display device is disadvantageous in terms of cost.

Thus, a method for configuring a 3D display substrate and a touch panel substrate to be common by configuring a parallax barrier used for 3D display under a substrate and configuring a transparent electrode used as a touch panel on the substrate has been proposed. According to this method, the total substrate thickness can be configured to be thinner than that of a display device according to a system in the related art (see Patent Document 1).

### CITATION LIST

### Patent Literature

PTL 1: International Publication Pamphlet No. 09/069358

### SUMMARY

### Technical Problem

However, in the display device disclosed in Patent Document 1, the touch panel is a surface type, and accordingly, there is a problem in that it is difficult to respond to a multi-touch. In addition, in a display device having a 3D display function, it is desirable to include a display switching function between a 3D display function and an ordinary 2D display function. However, in the display device disclosed in Patent Document 1, a unit that realizes the 3D display function is a fixed parallax barrier or a lenticular lens, and accordingly, there is a problem in that an image is displayed in a 3D display all the time.

The present disclosure has been made in consideration of such problems, and it is desirable to provide a display device and an electronic apparatus enabling a user to input information while displaying a 3D image and a 2D image in a switchable manner.

### Solution to Problem

In an embodiment, there is provided a display device including a pixel unit including a first substrate; a touch sensor unit including a second substrate; and a liquid crystal layer formed between the pixel unit and the touch sensor unit. The touch sensor unit includes a detection electrode capacitively coupled with a driving electrode, both the detection electrode and the driving electrode being formed on a side of the touch sensor unit facing the liquid crystal layer.

In another embodiment, there is provided an electronic apparatus including a control unit; display device operable to receive control signals from the control unit, the display device including: a pixel unit including a first substrate, a touch sensor unit including a second substrate, and a liquid crystal layer formed between the pixel unit and the touch sensor unit, wherein the touch sensor unit includes a detection electrode capacitively coupled with a driving electrode, both the detection electrode and the driving electrode being formed on a side of the touch sensor unit facing the liquid crystal layer.

In order to solve the above problem, an embodiment of the present disclosure is a display device including:
a pixel unit;
a display switching functioning unit; and
a sensor unit,
wherein the pixel unit includes a plurality of pixels,
wherein the display switching functioning unit is capable of performing switching between a 3D display and a 2D display of an image that is based on light emitted from the pixel unit,
wherein the sensor unit detects being in contact with or in proximity to an object,
wherein the display switching functioning unit is disposed on the pixel unit in a stacked manner, and
wherein the display switching functioning unit includes the sensor unit in the inside.

Another embodiment of the present disclosure is an electronic apparatus including at least one display device,
wherein the display device includes a pixel unit, a display switching functioning unit, and a sensor unit,
wherein the pixel unit includes a plurality of pixels,
wherein the display switching functioning unit is capable of performing switching between a 3D display and a 2D display of an image that is based on light emitted from the pixel unit,
wherein the sensor unit detects being in contact with or in proximity to an object,
wherein the display switching functioning unit is disposed on the pixel unit in a stacked manner, and
wherein the display switching functioning unit includes the sensor unit in the inside.

While the pixel unit is not particularly limited as long as it has a function of a display pixel, as the pixel unit, for example, there is an organic field light emitting device, a liquid crystal display device, an inorganic EL device, an LED device, an SED device, or an FED device. In a case where the liquid crystal display device is used, it is preferable to perform an image display by additionally disposing a backlight.

While the display switching functioning unit is not particularly limited as long as it has a function for switching between a 2D display and a 3D display of a displayed image, for example, as the display switching functioning unit, there is a unit displaying an image that is based on incident light and being capable of performing switching between a 3D display and a 2D display of the image by changing an optical path of the incident light. As a specific configuration of the display switching functioning unit, for example, there is a configuration in which an optical path changing functioning unit is disposed between the driving electrode and the opposing electrode. As the display switching functioning unit, for example, there is a liquid crystal lens, a liquid lens, or a liquid crystal barrier parallax, and, as the optical path changing functioning unit, for example, there is a liquid crystal layer or a staked body of a polar liquid layer and a non-polar liquid layer, but the optical path changing functioning unit is not limited thereto.

While the sensor unit is not particularly limited as long as it has a function for detecting the position, the sensor unit is preferably a touch sensor detecting a contact position by being in contact with an object. As the type of the touch sensor, there is a resistive film type, a capacitive type, a sound type, an infrared-ray type, a strain gage type, an image processing type, a pressure-sensitive resistor type, or the like, and, among them, a capacitive-type touch sensor is preferable. As the configuration of the capacitive-type touch sensor, more specifically, for example, there is a configuration in which a dielectric is disposed between the driving electrode and the opposing electrode. In addition, as the type of the capacitive touch sensor, there is a projection type, a surface type, or the like, and the projection type is preferable.

### Advantageous Effects of Invention

According to an embodiment of the present disclosure, a display switching functioning unit capable of performing switching between a 3D display and a 2D display of an image and a sensor unit detecting being in contact with or in proximity to an object can be integrally configured. From this, a user can input information while a 3D image or a 2D image is displayed in a switchable manner. By using this superior display device, an electronic apparatus having high performance can be realized.

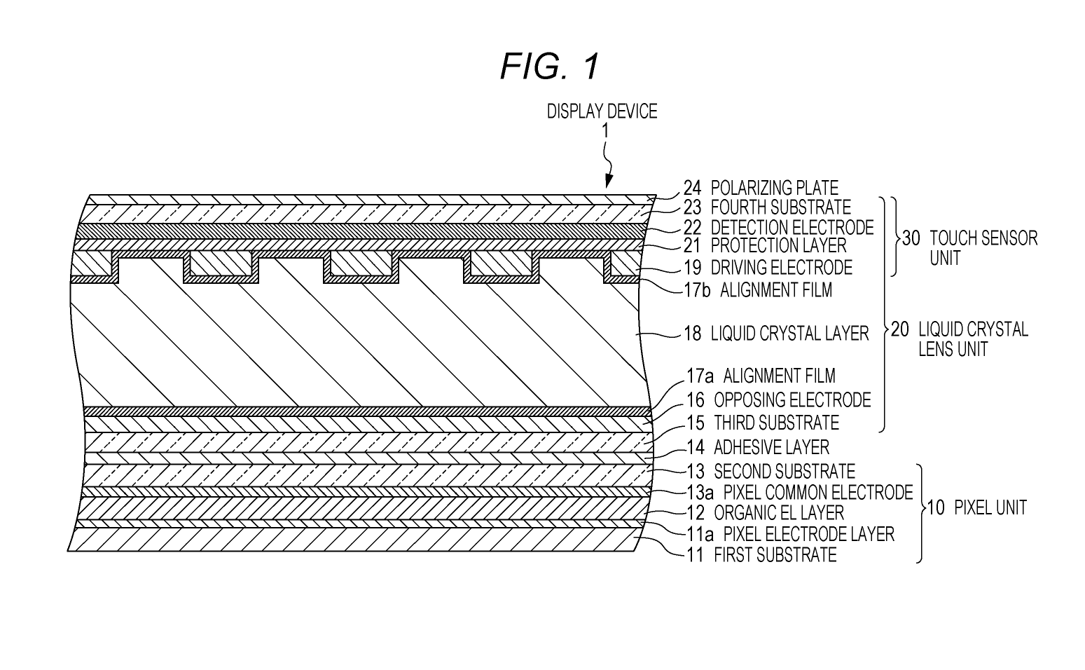

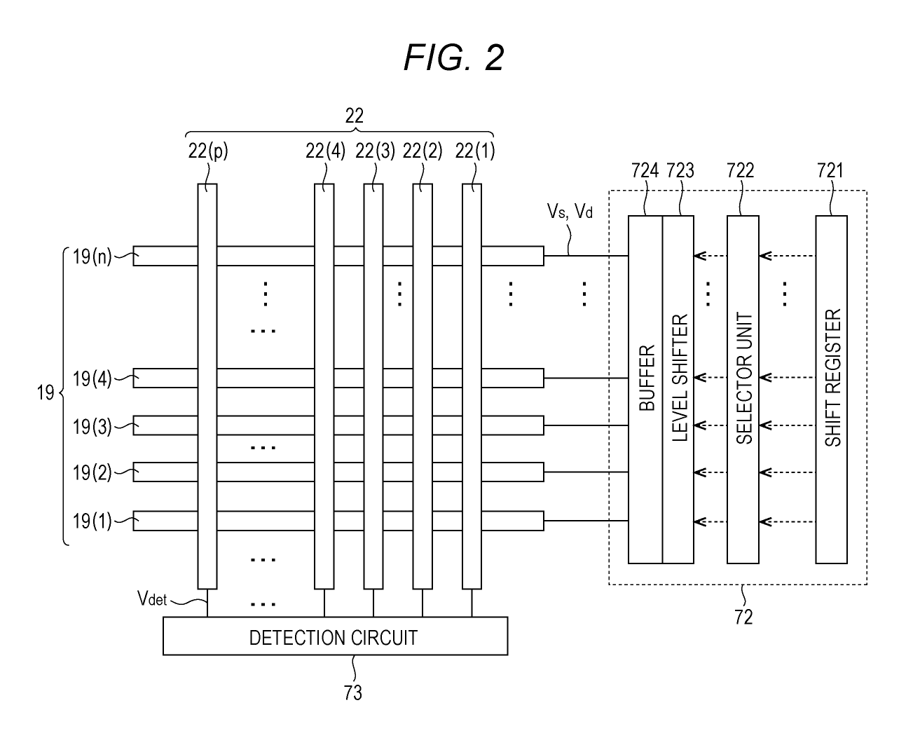

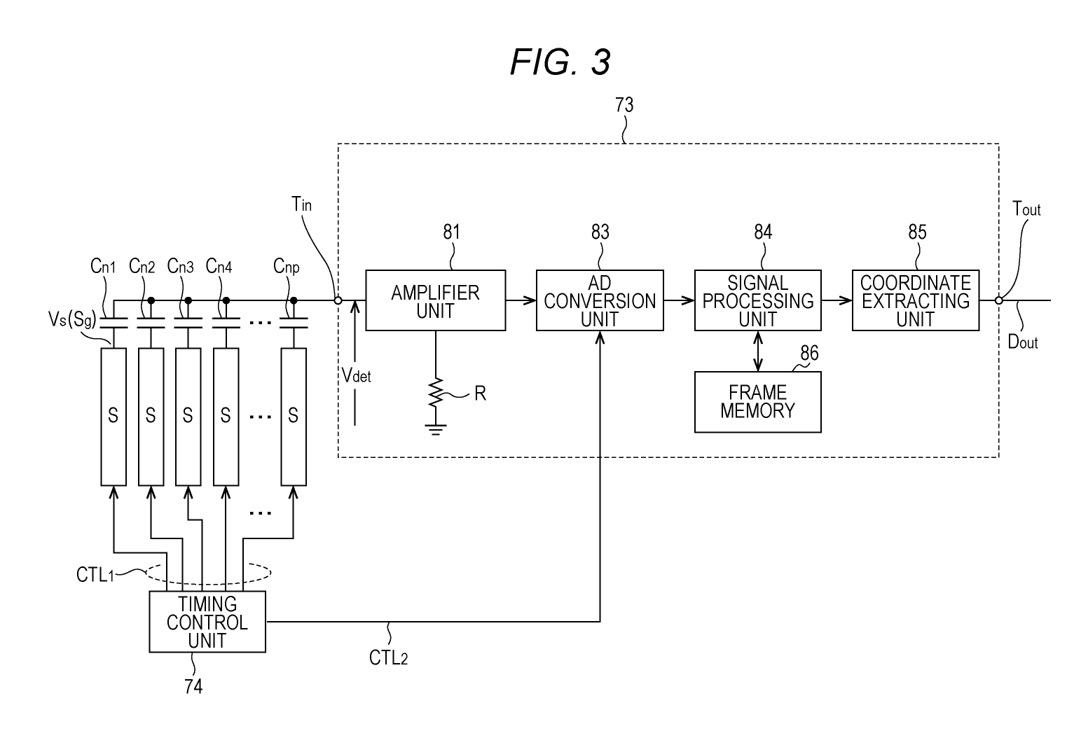

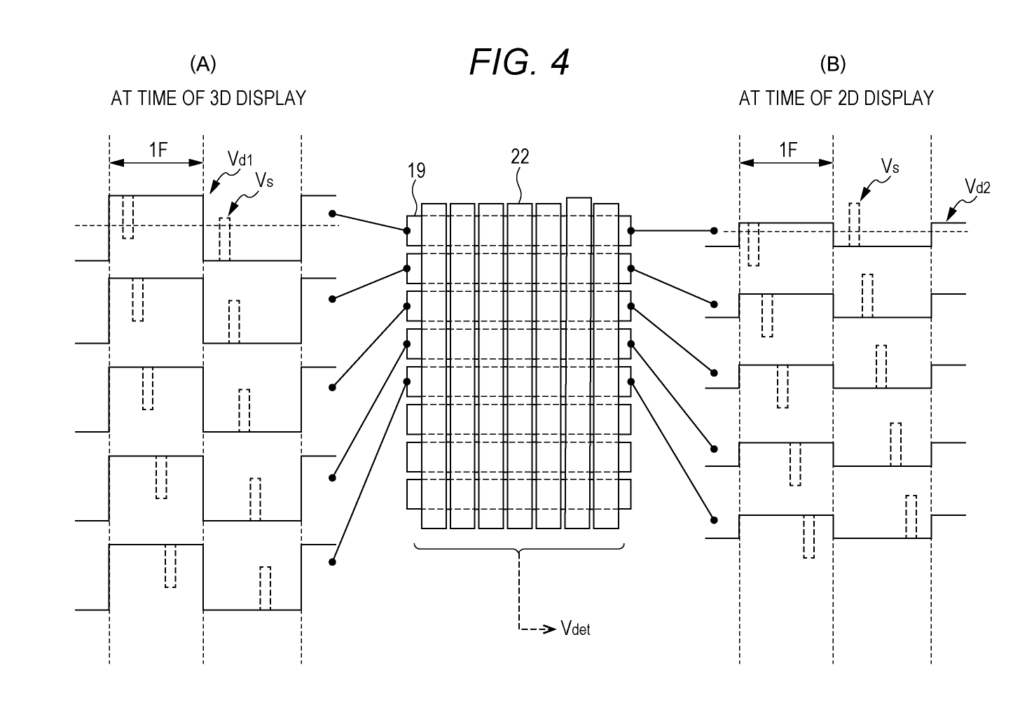

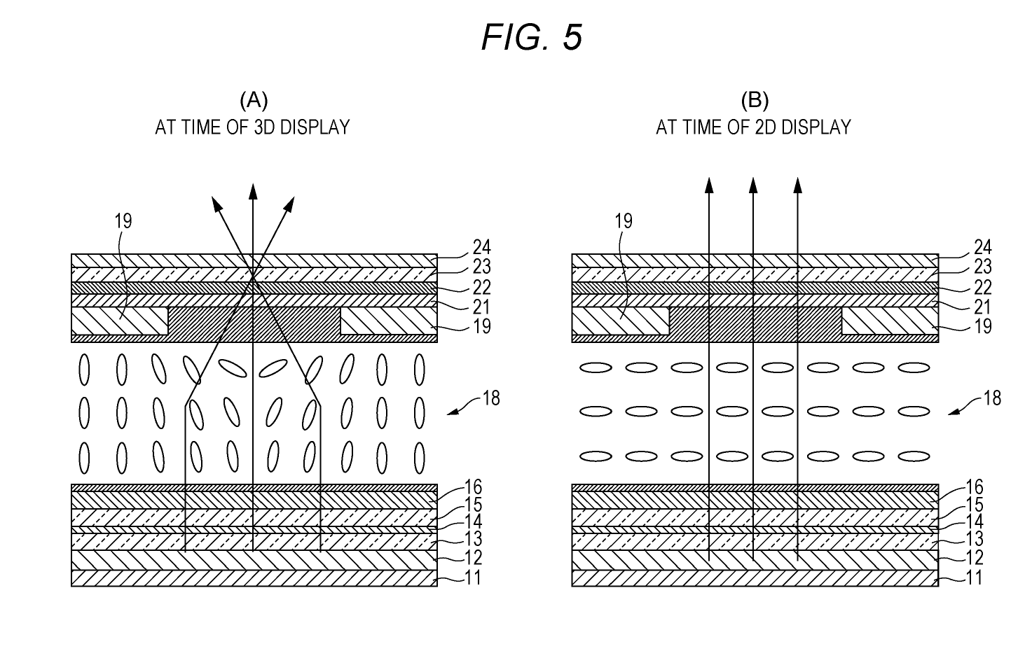

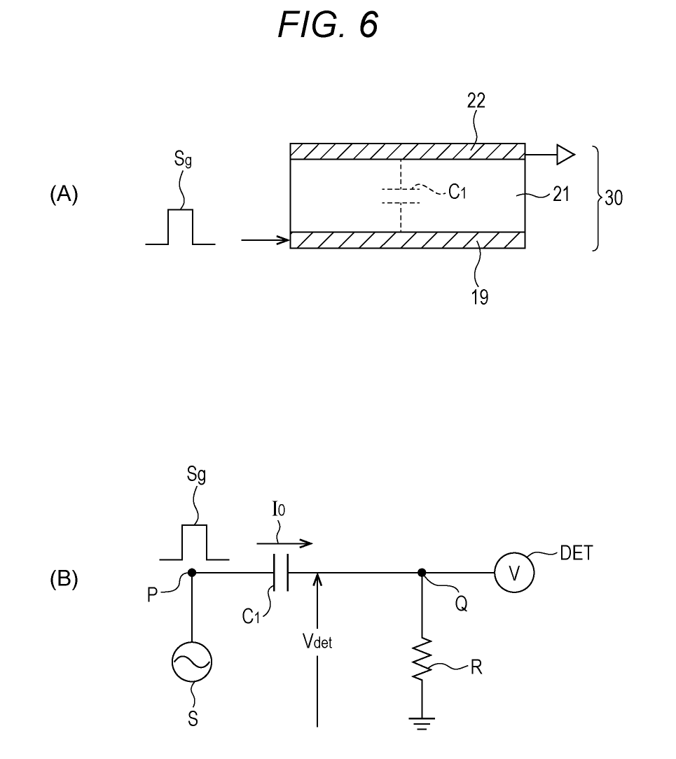

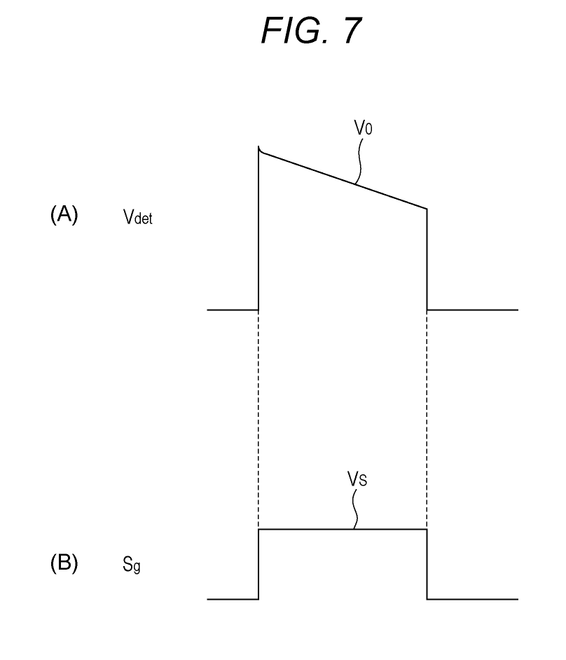

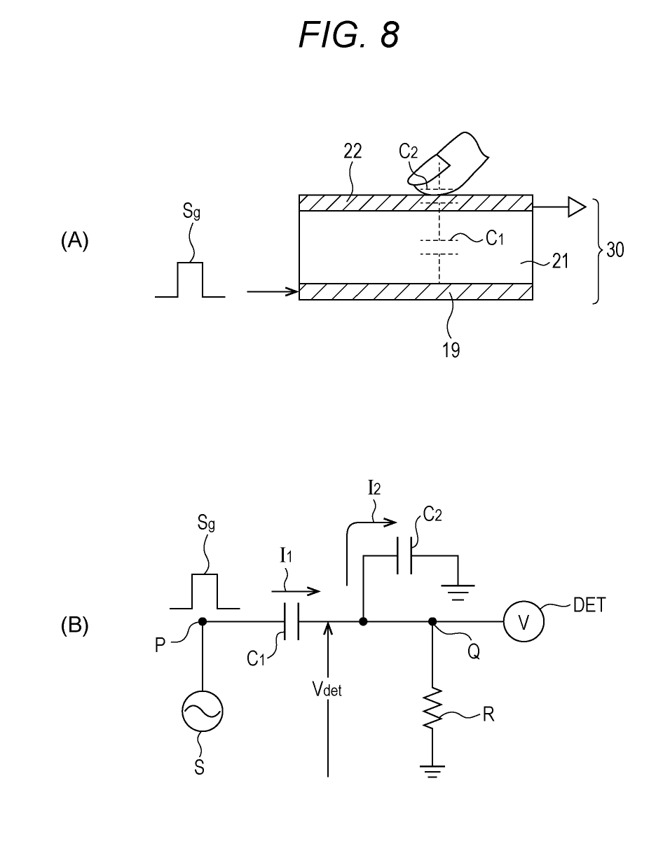

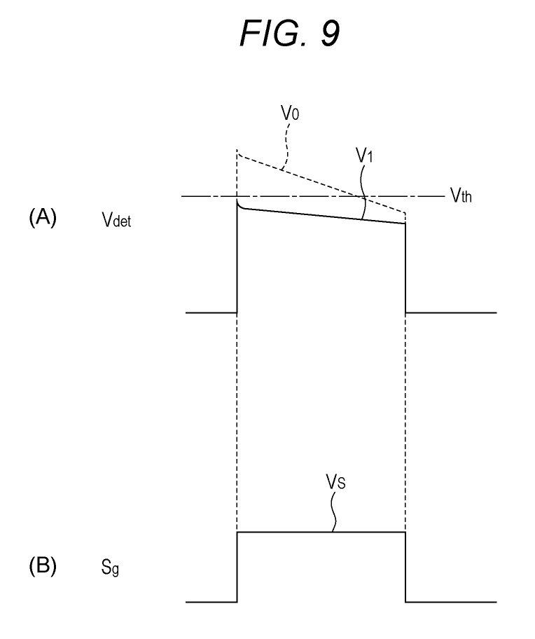

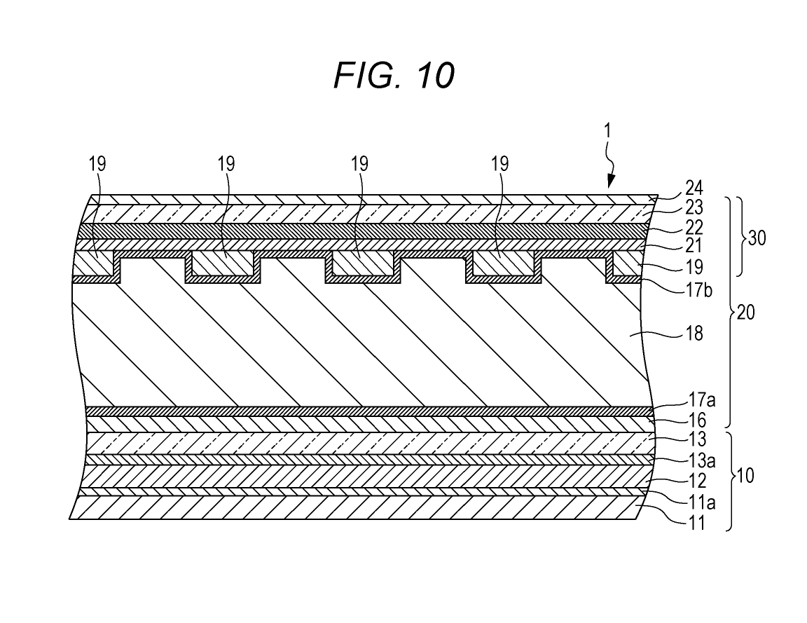

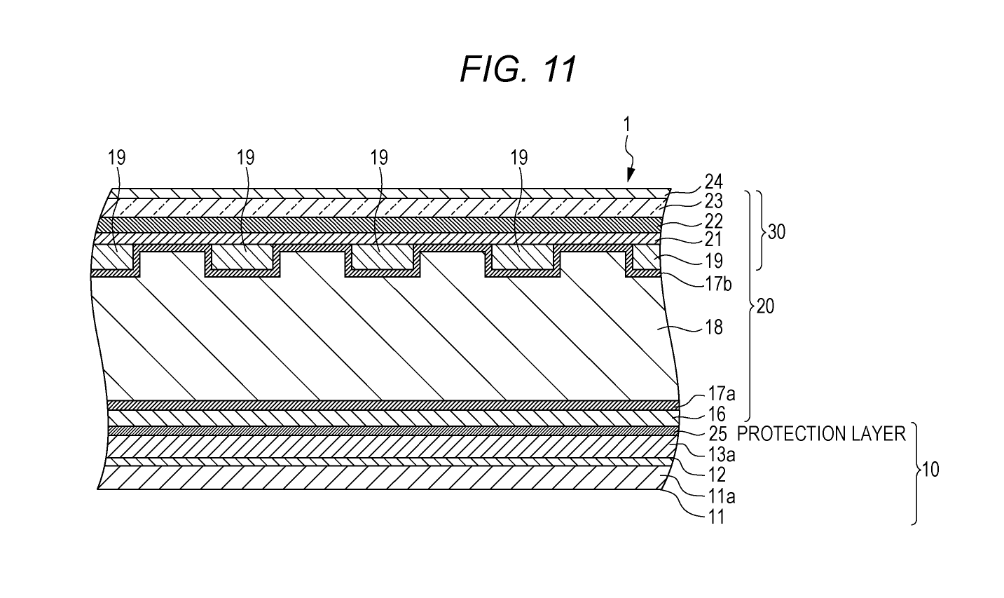

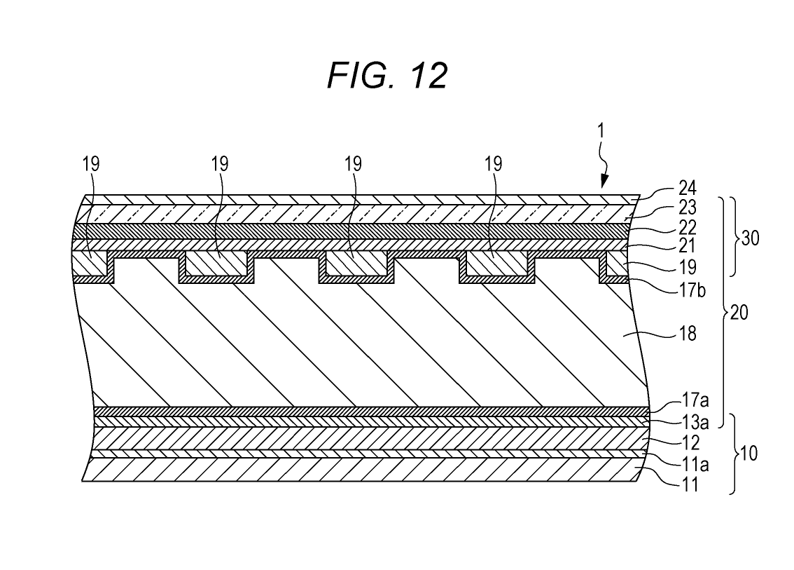

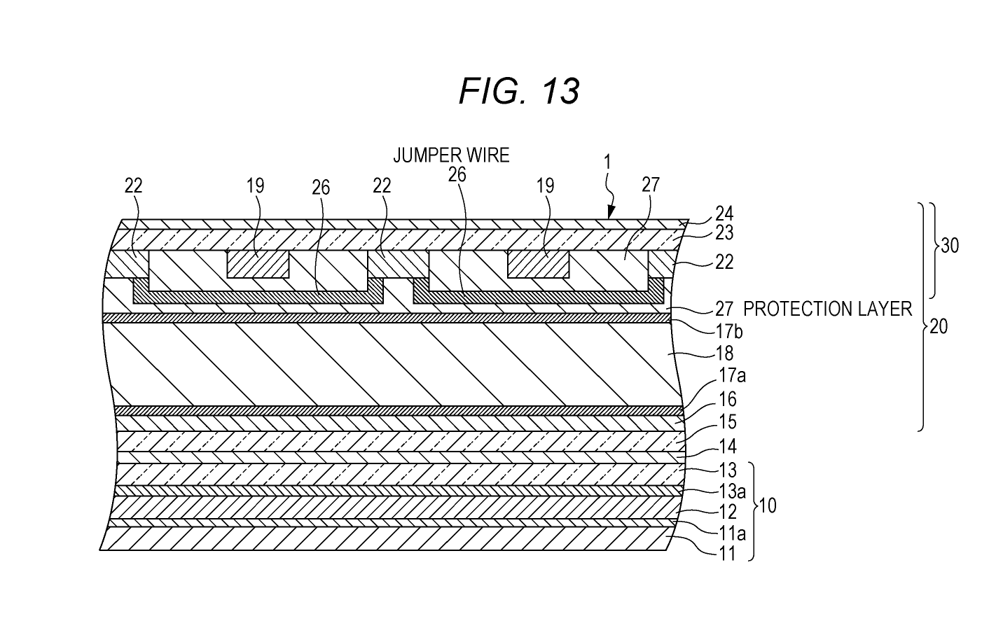

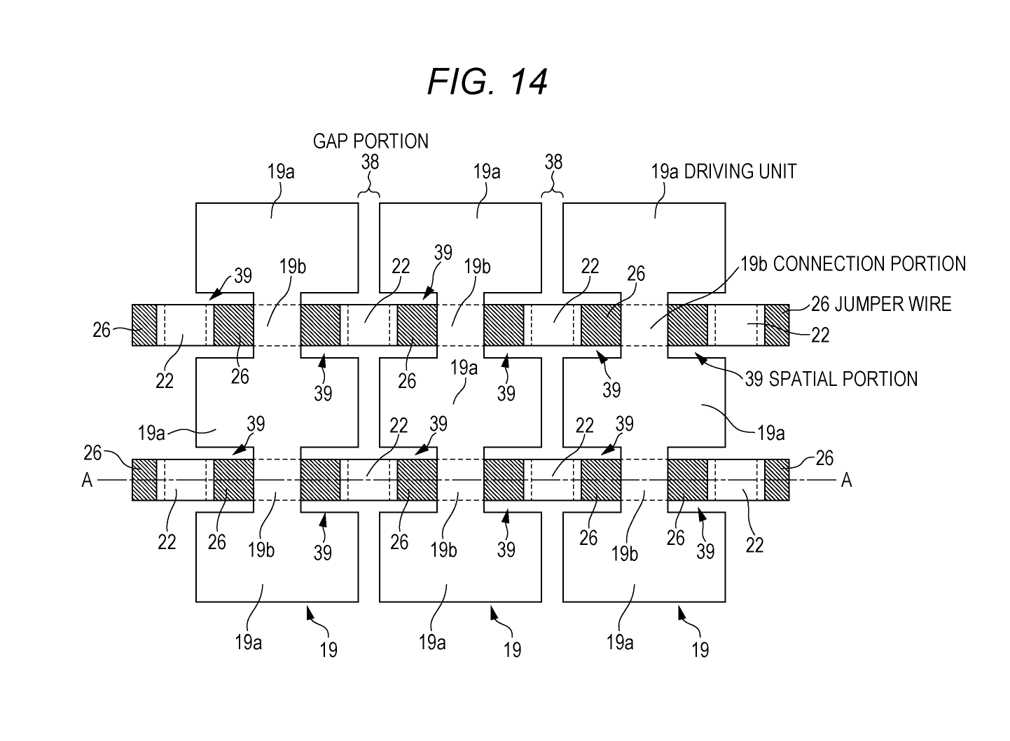

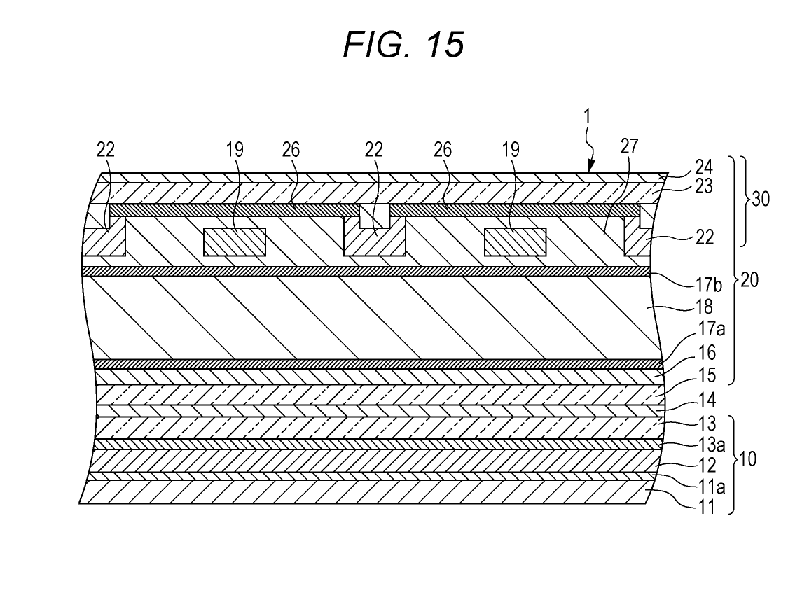

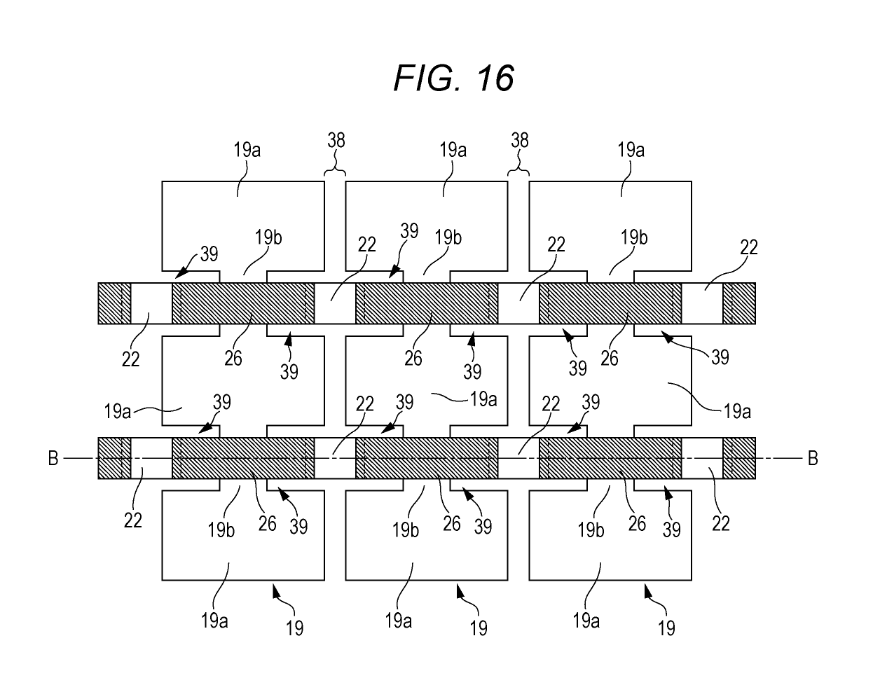

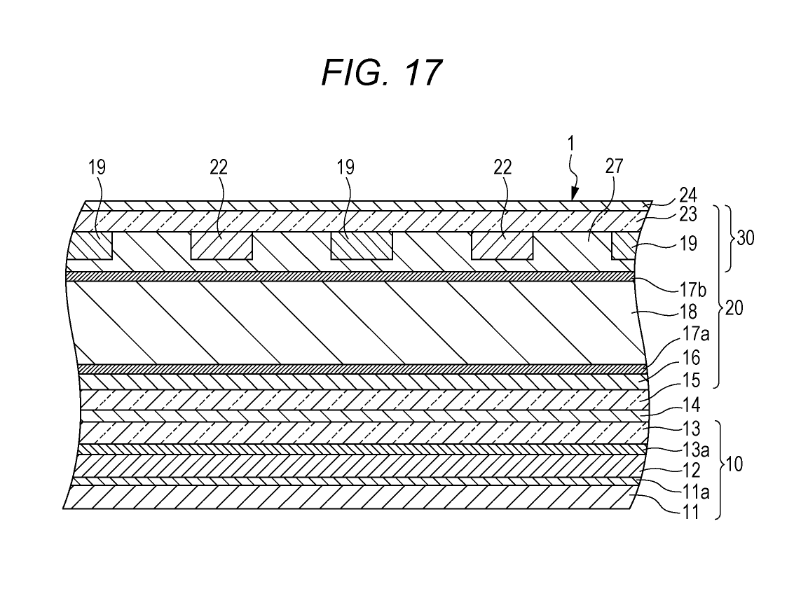

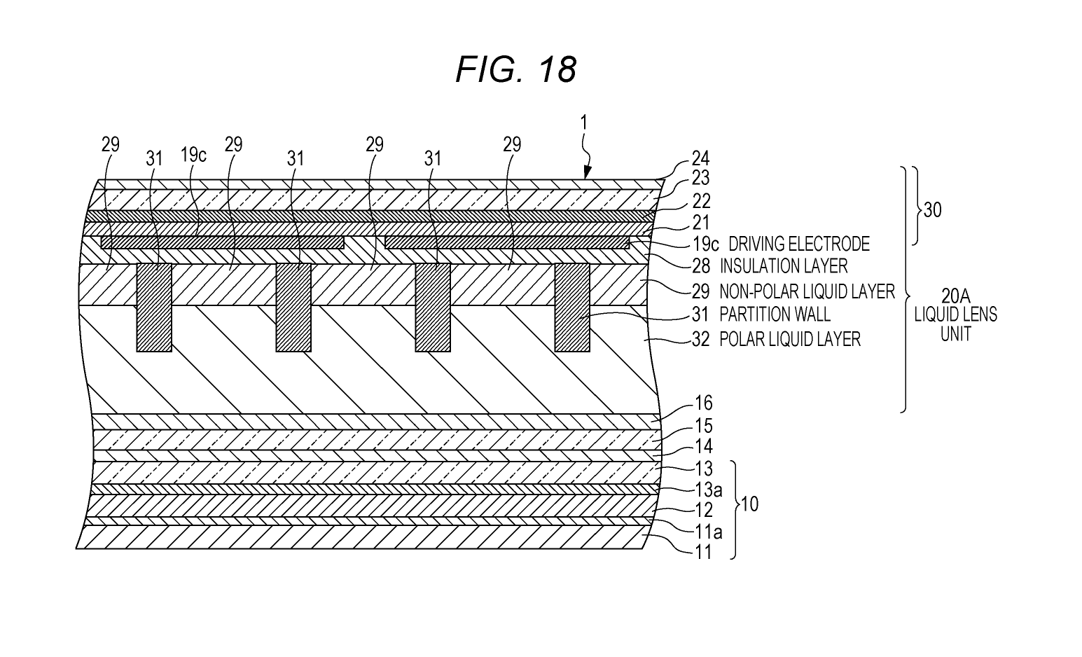

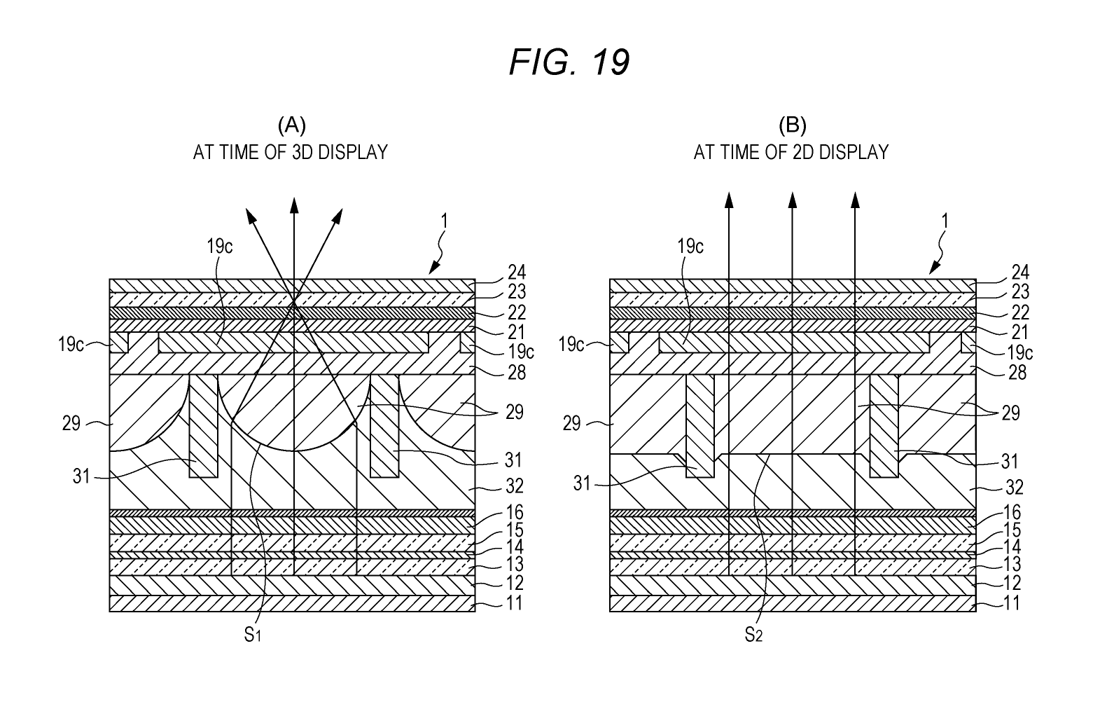

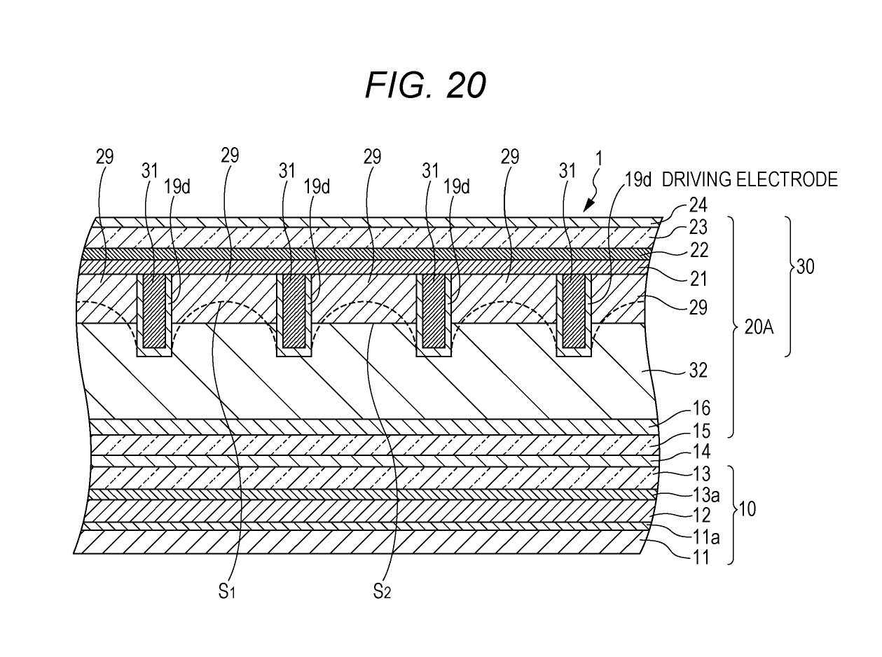

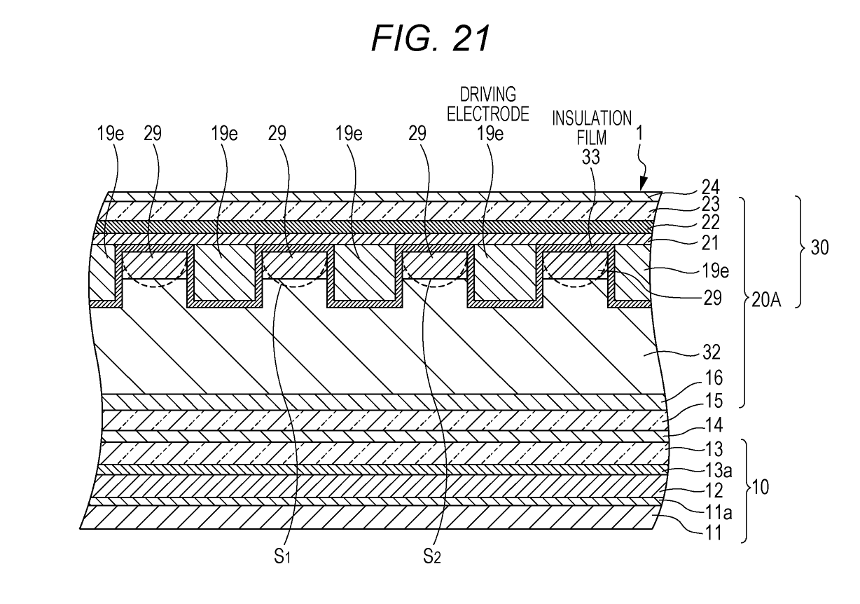

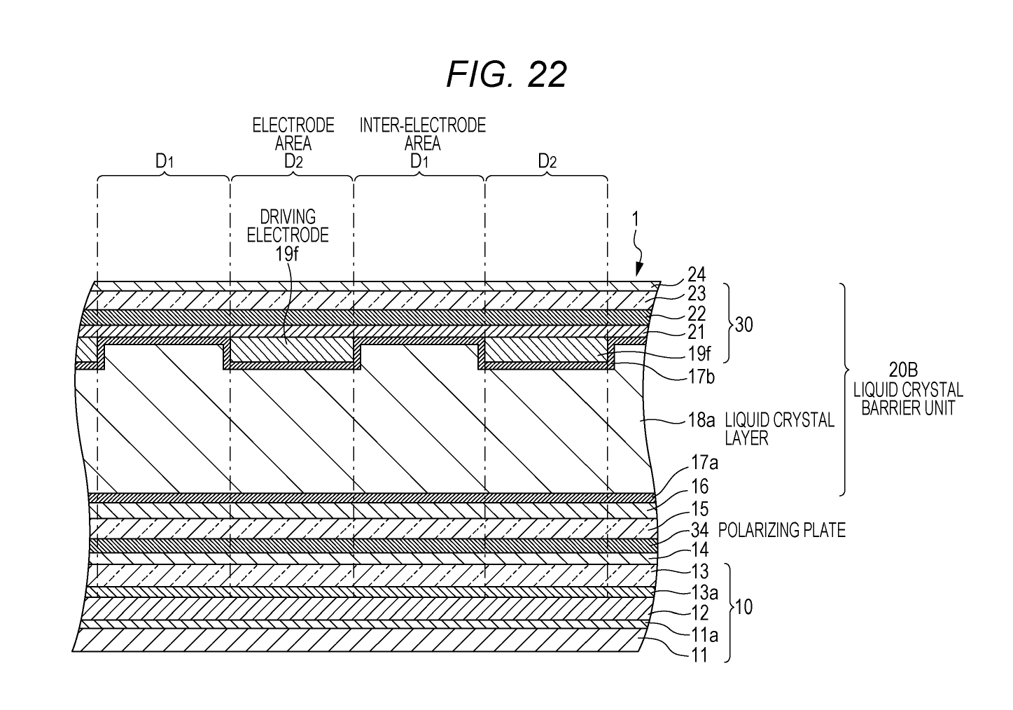

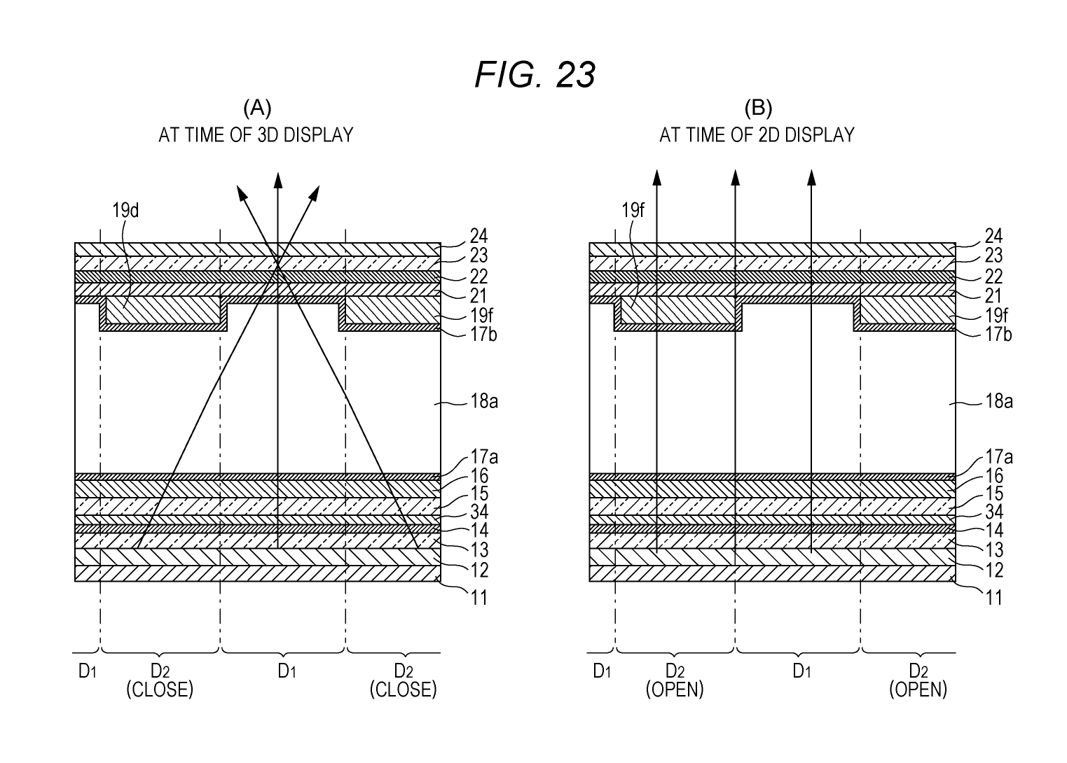

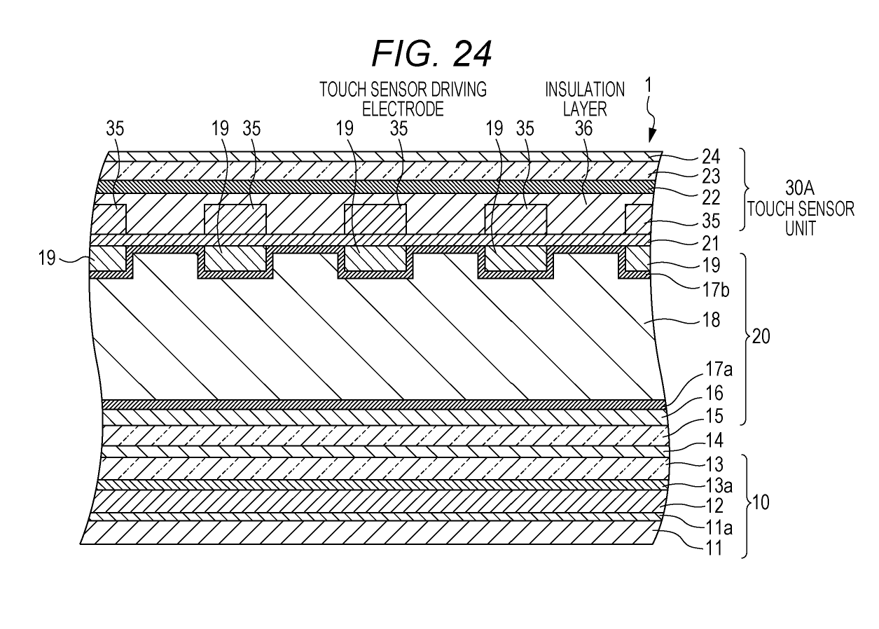

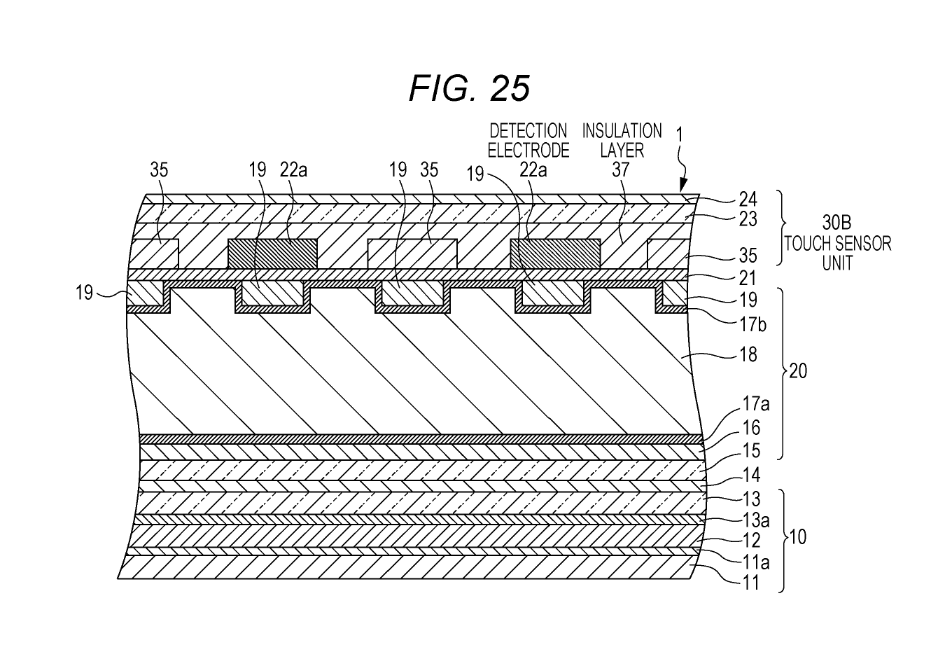

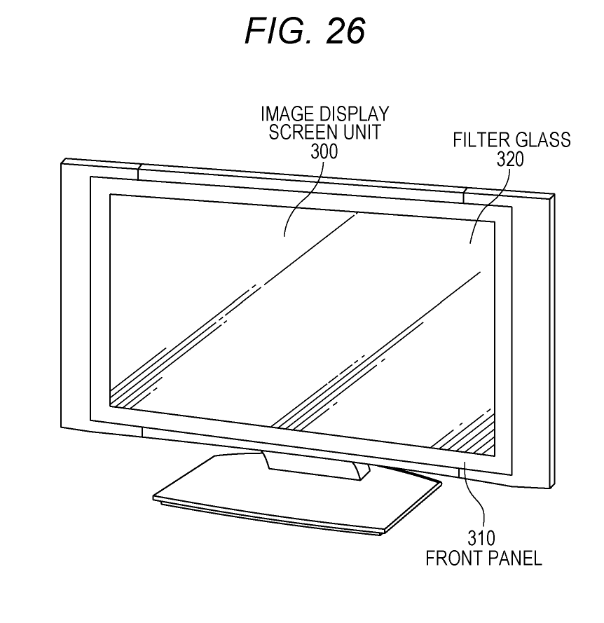

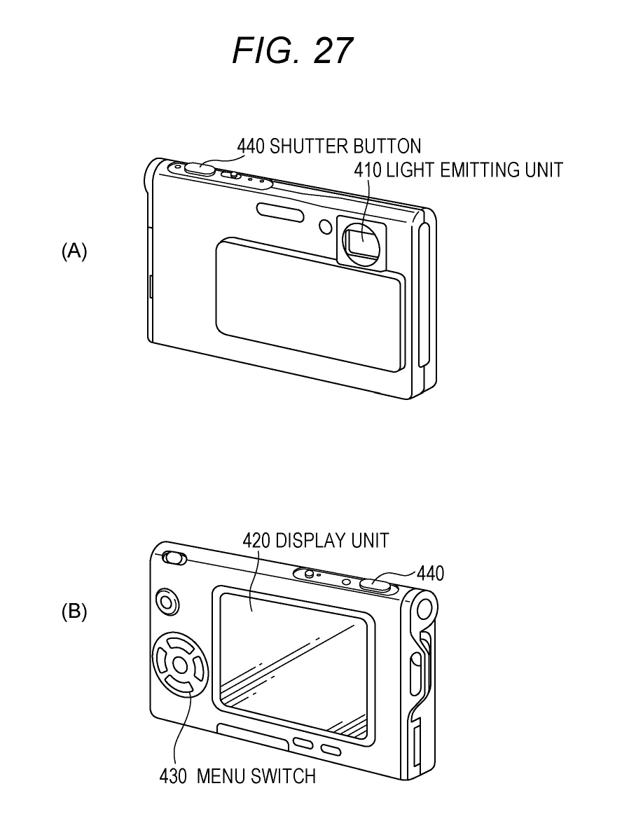

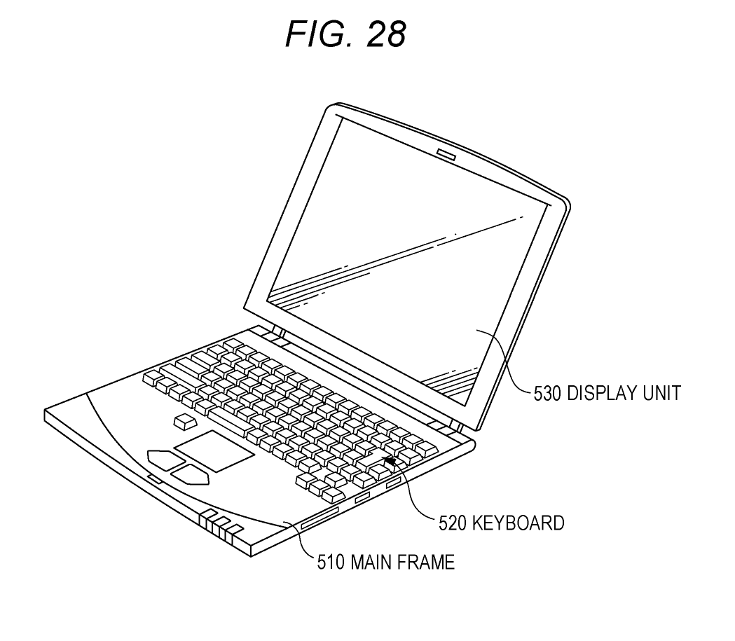

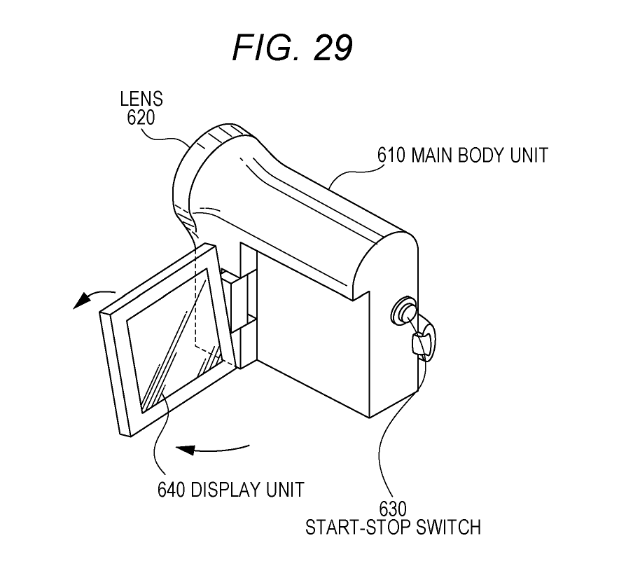

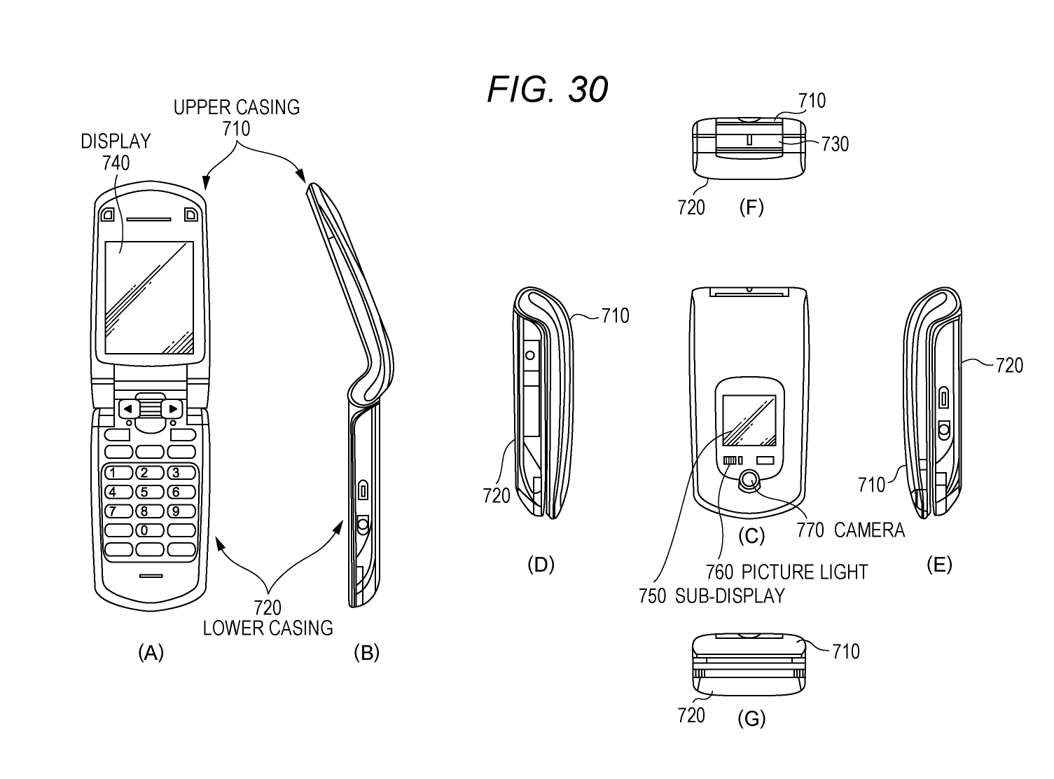

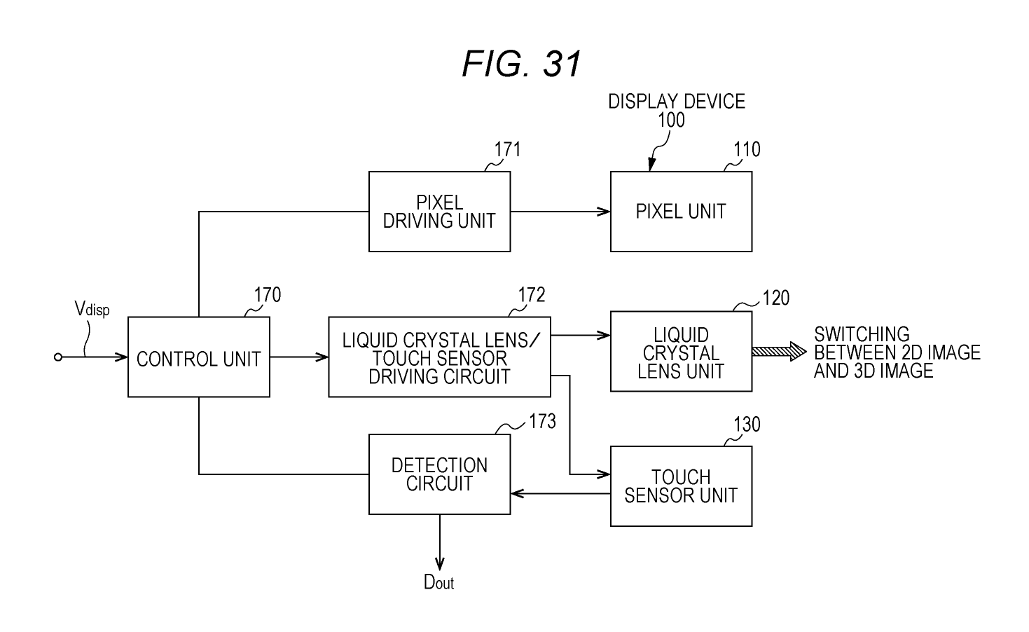

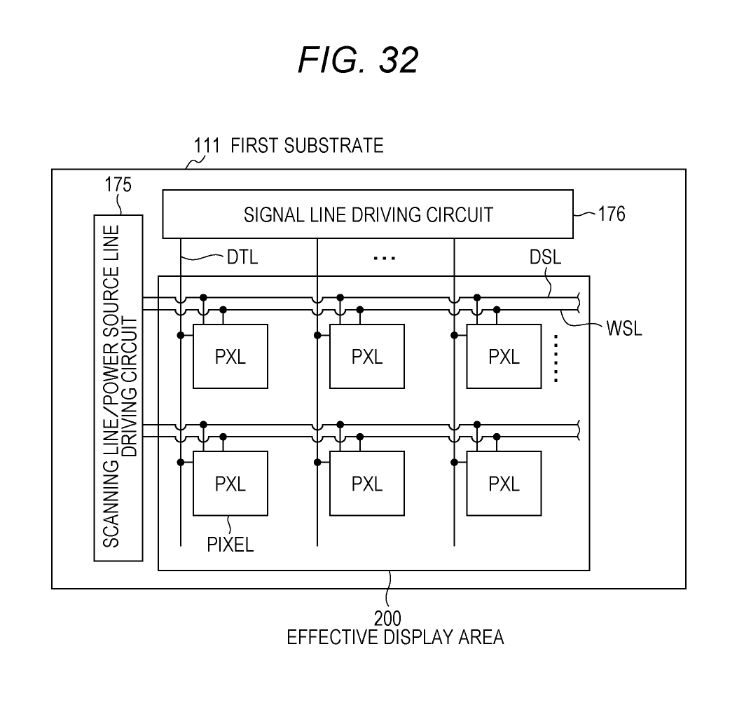

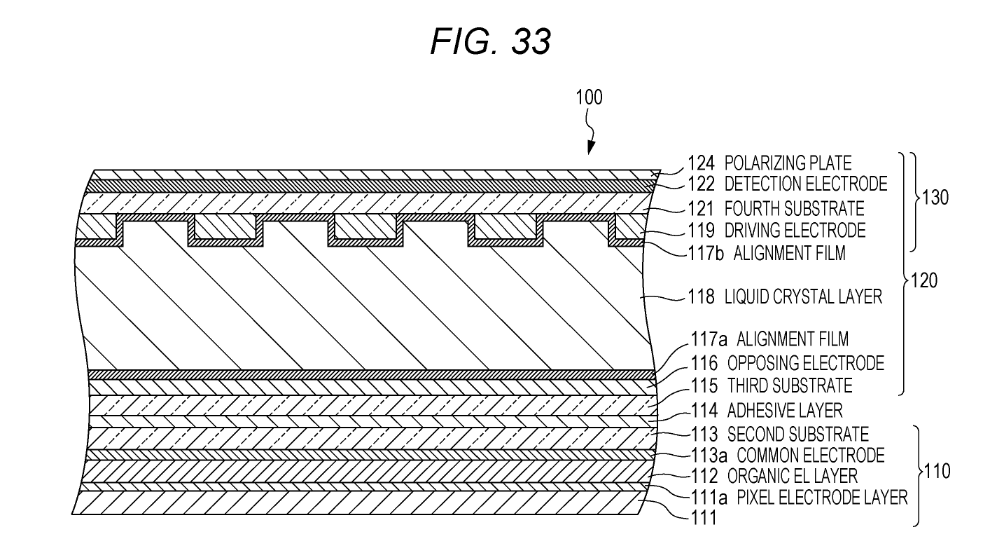

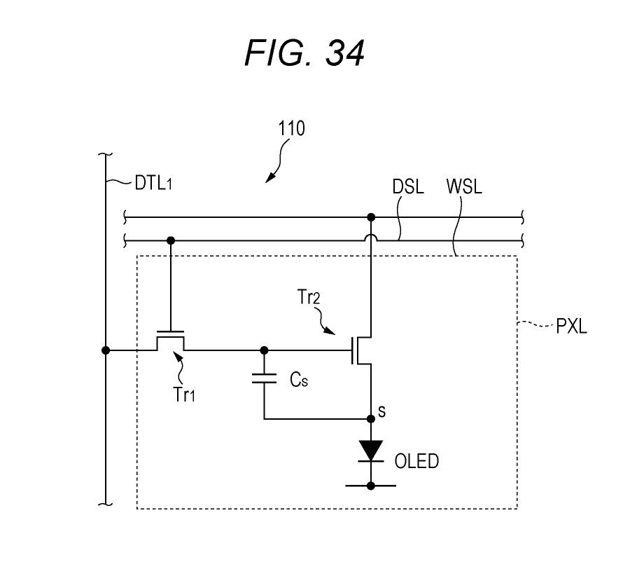

### BRIEF DESCRIPTION OF DRAWINGS

[FIG. 1] FIG. 1 is a cross-sectional view that schematically illustrates the structure of a display device according to a first embodiment of the present disclosure.

[FIG. 2] FIG. 2 is an outlined line drawing and a plan view that illustrate an example of a driving circuit of a liquid crystal lens unit 20 and a touch sensor unit 30 and a detection circuit together with a layout of a sensor driving electrode and a detection electrode.

[FIG. 3] FIG. 3 is a functional block diagram that illustrates one example of the configuration of a detection circuit.

[FIG. 4] FIG. 4 is an outlined line drawing that illustrates drive signal waveforms used for a 3D display, a 2D display, and a sensor.

[FIG. 5] FIG. 5 is a cross-sectional view that illustrates display operations of the liquid crystal lens unit 20 at the time of performing a 3D display and a 2D display.

[FIG. 6] FIG. 6 is a cross-sectional view that illustrates the operation of the touch sensor unit 30 at the time of no contact of a finger.

[FIG. 7] FIG. 7 is an outlined line diagram that illustrates an example of waveforms of a drive signal and a detection signal for a touch sensor at the time of no contact of a finger.

[FIG. 8] FIG. 8 is a cross-sectional view that illustrates the operation of the touch sensor unit 30 at the time of contact of a finger.

[FIG. 9] FIG. 9 is an outlined line diagram that illustrates an example of waveforms of a drive signal and a detection signal for the touch sensor at the time of contact of a finger.

[FIG. 10] FIG. 10 is a cross-sectional view that schematically illustrates the structure of a display device according to a second embodiment of the present disclosure.

[FIG. 11] FIG. 11 is a cross-sectional view that schematically illustrates the structure of a display device according to a third embodiment of the present disclosure.

[FIG. 12] FIG. 12 is a cross-sectional view that schematically illustrates the structure of a display device according to a fourth embodiment of the present disclosure.

[FIG. 13] FIG. 13 is a cross-sectional view that schematically illustrates the structure of a display device according to a fifth embodiment of the present disclosure.

[FIG. 14] FIG. 14 is a plan view seen from the upper face of the display device according to the fifth embodiment of the present disclosure.

[FIG. 15] FIG. 15 is a cross-sectional view that schematically illustrates the structure of a display device according to a sixth embodiment of the present disclosure.

[FIG. 16] FIG. 16 is a plan view seen from the upper face of the display device according to the sixth embodiment of the present disclosure.

[FIG. 17] FIG. 17 is a cross-sectional view that schematically illustrates the structure of a display device according to a seventh embodiment of the present disclosure.

[FIG. 18] FIG. 18 is a cross-sectional view that schematically illustrates the structure of a display device according to an eighth embodiment of the present disclosure.

[FIG. 19] FIG. 19 is a cross-sectional view that illustrates display operations of a liquid lens unit 20A at the time of a 3D display and at the time of a 2D display.

[FIG. 20] FIG. 20 is a cross-sectional view that schematically illustrates the structure of a display device according to a ninth embodiment of the present disclosure.

[FIG. 21] FIG. 21 is a cross-sectional view that schematically illustrates the structure of a display device according to a tenth embodiment of the present disclosure.

[FIG. 22] FIG. 22 is a cross-sectional view that schematically illustrates the structure of a display device according to an eleventh embodiment of the present disclosure.

[FIG. 23] FIG. 23 is a cross-sectional view that illustrates display operations of a liquid crystal barrier unit 20B at the time of a 3D display and at the time of a 2D display.

[FIG. 24] FIG. 24 is a cross-sectional view that schematically illustrates the structure of a display device according to a twelfth embodiment of the present disclosure.

[FIG. 25] FIG. 25 is a cross-sectional view that schematically illustrates the structure of a display device according to a thirteenth embodiment of the present disclosure.

[FIG. 26] FIG. 26 is a perspective view that illustrates a first example applied to an electronic apparatus.

[FIG. 27] FIG. 27 is a perspective view that illustrates a second example applied to an electronic apparatus.

[FIG. 28] FIG. 28 is a perspective view that illustrates a third example applied to an electronic apparatus.

[FIG. 29] FIG. 29 is a perspective view that illustrates a fourth example applied to an electronic apparatus.

[FIG. 30] FIG. 30 is a perspective view that illustrates a fifth example applied to an electronic apparatus.

[FIG. 31] FIG. 31 is a functional block diagram that illustrates the whole configuration of a display device reviewed by the present disclosers.

[FIG. 32] FIG. 32 is a block diagram that illustrates an example of a peripheral circuit in a pixel driving unit 171.

[FIG. 33] FIG. 33 is a cross-sectional view that schematically illustrates the structure of a display device reviewed by the present disclosers.

[FIG. 34] FIG. 34 is an outlined line diagram that illustrates an example of the circuit configuration of a pixel unit 110.

### DESCRIPTION OF EMBODIMENTS

In order to solve the above-described problems, the present disclosers and the others have reviewed a display device that has a display switching function between a 3D display function and an ordinary 2D display function and a touch sensor function together.

FIG. 31 is a functional block diagram that schematically illustrates the whole configuration of a display device 100 reviewed by the present disclosers and the others. The display device 100 includes a pixel unit 110, a liquid crystal lens unit 120, and a touch sensor unit 130.

As illustrated in FIG. 31, in addition to the above-described configuration, the display device 100 includes a control unit 170, a pixel driving unit 171 that is used for driving the pixel unit 110 and the like, a driving circuit 172 of the liquid crystal lens unit 120 and the touch sensor unit 130, and a detection circuit 173.

The control unit 170 is a circuit that supplies control signals to the pixel driving unit 171, the driving circuit 172 of the liquid crystal lens unit 120 and the touch sensor unit 130, and the detection circuit 173 based on a video signal V_{disp} supplied from the outside and performs control of the units to operate at predetermined timing. More specifically, the control unit 170 supplies a video signal S, which is based on the video signal V_{disp}, to the pixel driving unit 171 and supplies a predetermined drive signal to the liquid crystal lens unit 120 by controlling the driving circuit of the liquid crystal lens unit 120 and the touch sensor unit 130.

The pixel driving unit 171 drives the pixel unit 110 based on the video signal S supplied from the control unit 170. This pixel driving unit 171 is configured to include a video signal processing circuit, for example, performing a predetermined correction process for the video signal S, a timing generating circuit (any one thereof is not illustrated in the figure) used for controlling timings for display driving and sensor driving, and various drivers.

FIG. 32 illustrates an example of the configuration of a peripheral circuit (driver) of the pixel unit 110.

As illustrated in FIG. 32, within an effective display area 200, a plurality of pixels PXL are two-dimensionally arranged, for example, in a matrix pattern, and, on the periphery of the effective display area 200, a scanning line-power source line driving circuit 175 and a signal line driving circuit 176 are arranged. Each pixel PXL is connected to a scanning line WSL, a power source line DSL, and a signal line DTL.

The scanning line-power source line driving circuit 175 includes a scanning line driving circuit and a power source line driving circuit not illustrated in the figure. The scanning line driving circuit sequentially selects each pixel by sequentially applying a selection pulse to a plurality of scanning lines WSL at predetermined timing. More specifically, the scanning line driving circuit outputs a voltage Vₒₙ₁ used for setting a write transistor Tr₁, to be described later, to be in the On state and a voltage V_{off1} used for setting the write transistor Tr₁ to be in the Off state in a time-divisional manner. The power source line driving circuit controls a light emission operation and a light quenching operation of each pixel by sequentially applying control pulses to a plurality of power source lines DSL at predetermined timing. More specifically, the power source line driving circuit outputs a voltage V_{H1} used for causing a current I_{ds} to flow through a driving transistor Tr₂ to be described later and a voltage V_{L1} used for causing the current I_{ds} not to flow through the driving transistor Tr₂ in a time-divisional manner.

The signal line driving circuit 176 generates an analog video signal corresponding to the video signal S input from the outside and applies the generated video signal to each signal line DTL at predetermined timing. From this, the video signal is written into a pixel that is selected by the scanning line driving circuit.

FIG. 33 is a cross-sectional view that illustrates the configuration of the vertical cross-section of the pixel PXL of the display device 100.

As illustrated in FIG. 33, in the PXL unit of this display device 100, the liquid crystal lens unit 120 and the touch sensor unit 130 are sequentially stacked on the pixel unit 110. The pixel unit 110 includes a plurality of organic EL devices as display pixels. The liquid crystal lens unit 120 displays an image by passing light emitted from the pixel unit 110 and has a display switching function. The display switching function is a function for displaying an image as a 3D image or a 2D image in a switchable manner, for example, by changing a guided wave optical path of light incident to the liquid crystal lens unit 120 from the pixel unit 110 and outputting the light. The touch sensor unit 130 has a capacitive-type touch sensor function. All the pixel unit 110, the liquid crystal lens unit 120, and the touch sensor unit 130 are configured to be driven through a pair of electrodes.

In the pixel unit 110, a pixel electrode layer 111a, an organic EL layer 112, a pixel common electrode 113a, and a second substrate 113 are sequentially stacked on a first substrate 111. The pixel electrode layer 111a is configured by a plurality of pixel electrodes, and each pixel electrode serves as an anode used for injecting holes into the organic EL layer 112. The organic EL layer 112, for example, is common to pixels and is a white light emitting layer emitting white light by recombination of holes and electrons. In addition, the pixel common electrode 113a is an electrode that is common to the pixels and, for example, serves as a cathode injecting electrons into the organic EL layer 112.

The liquid crystal lens unit 120 has a configuration in which a liquid crystal layer 118 is disposed between an opposing electrode 116 disposed on a third substrate 115 and a driving electrode 119 disposed on a fourth substrate 121. The liquid crystal lens unit 120 is a focus-variable lens of which the focal position moves as the refractive index thereof changes in accordance with a voltage applied to the liquid crystal layer 118. In accordance with the change in the refractive index according to the applied voltage, switching between a 3D display and a 2D display is performed. On faces of the opposing electrode 116 and the driving electrode 119, which are located on the side of the liquid crystal layer 118, alignment films 117a and 117b are formed.

The pixel unit 110 and the liquid crystal lens unit 120 are bonded together through an adhesive layer 114. More specifically, the second substrate 113 of the pixel unit 110 and the third substrate 115 of the liquid crystal lens unit 120 are bonded together.

The touch sensor unit 130 has a configuration in which a fourth substrate 121 is disposed between the driving electrode 119 and the detection electrode 122. From this, a capacitive device is formed between the driving electrode 119 and the detection electrode 122. In other words, the liquid crystal lens unit 120 and the touch sensor unit 130 are driven by the common driving electrode 119.

FIG. 34 illustrates an example of the circuit configuration of the pixel PXL.

As illustrated in FIG. 34, each pixel unit 110 includes an organic EL device (OLED), the write (for sampling) transistor Tr₁, the driving transistor Tr₂, and a holding capacitor Cs. The write transistor Tr₁ and the driving transistor Tr₂, for example are n-channel MOS (Metal Oxide Semiconductor) type TFTs. The type of the TFTs is not particularly limited and, for example, may have an inversely staggering structure (so-called a bottom gate type) or a staggering structure (so-called a top gate type).

In each pixel, the gate of the write transistor Tr₁ is connected to the scanning line WSL, the drain is connected to the signal line DTL, and the source is connected to the gate of the driving transistor Tr₂ and one end of the holding capacitor Cs. The drain of the driving transistor Tr₂ is connected to the power source line DSL, and the source thereof is connected to the other end of the holding capacitor Cs and the anode of the organic EL device (OLED). The cathode of the organic EL device (OLED) is set to fixed electric potential and, here, is set to the ground (ground potential).

As above, the driving electrode of the liquid crystal lens unit 120 and the driving electrode of the touch sensor unit 130 are configured to be common and are formed on the substrate of the liquid crystal lens unit 120, whereby the liquid crystal lens unit 120 and the touch sensor unit 130 are integrated. From this, a display switching between the 3D display function and the 2D display function can be performed, and accordingly, a display device having a touch panel function can be formed thinner than a display device in the related art. In addition, by configuring the second and third substrates 113 and 115 to be common substrates, a display device of a further thinner type can be acquired.

However, in the display device employing such a configuration, the detection electrode 122 is formed with the fourth substrate 121, which is a display-side substrate of the liquid crystal lens unit 120, interposed therebetween, and thus, when the fourth substrate 121, for example, is a glass substrate, it is necessary to form patterns on both faces of the glass. Since a manufacturing process for forming patterns on both faces of the glass is very complicated, there is a problem in that the productivity is lowered. In addition, there is a problem in that there is an obstacle for grinding glass in accordance with a decrease in the thickness of the display device.

For the above-described problems, the present disclosers have eagerly advanced a research. Thus, the present disclosers has found that the above-described problems are solved by including the whole configuration of the touch sensor unit in the liquid crystal lens unit and reached the proposal of the present technology.

Hereinafter, embodiments of the present disclosure will be described in detail with reference to the drawings. The description will be presented in the following order.

1. First Embodiment (Display Device and Manufacturing Method Thereof)

2. Second Embodiment (Display Device and Manufacturing Method Thereof)

3. Third Embodiment (Display Device and Manufacturing Method Thereof)

4. Fourth Embodiment (Display Device and Manufacturing Method Thereof)

5. Fifth Embodiment (Display Device and Manufacturing Method Thereof)

6. Sixth Embodiment (Display Device and Manufacturing Method Thereof)

7. Seventh Embodiment (Display Device and Manufacturing Method Thereof)

8. Eighth Embodiment (Display Device and Manufacturing Method Thereof)

9. Ninth Embodiment (Display Device and Manufacturing Method Thereof)

10. Tenth Embodiment (Display Device and Manufacturing Method Thereof)

11. Eleventh Embodiment (Display Device and Manufacturing Method Thereof)

12. Twelfth Embodiment (Display Device and Manufacturing Method Thereof)

13. Thirteenth Embodiment (Display Device and Manufacturing Method Thereof)

14. Fourteenth Embodiment (Electronic Apparatus)

<1. First Embodiment>

<Display Device>

FIG. 1 is a cross-sectional view that illustrates the configuration of the vertical cross-section of a pixel (PXL) of a display device 1 according to a first embodiment.

As illustrated in FIG. 1, in addition to the above-described configuration, the display device 1 according to the first embodiment includes a pixel unit 10, a liquid crystal lens unit 20, and a touch sensor unit 30. In addition, the display device 1 includes a control unit 70, a pixel driving unit 71 that is used for driving the pixel unit 10 and the like, a driving circuit 72 of the liquid crystal lens unit and the touch sensor unit, and a detection circuit 73 (any thereof is not illustrated in the figure).

The control unit 70, the pixel driving unit 71, the driving circuit 72 of the liquid crystal lens unit and the touch sensor unit, and the detection circuit 73 are included in the display device 1 so as to have configurations, connections, and arrangements that are similar to corresponding parts (the control unit 170 to the detection circuit 173) included in the display device 100 illustrated in FIG. 31.

In addition, in the display device 1, the liquid crystal lens unit 20 and the touch sensor unit 30 are stacked in the mentioned order on the pixel unit 10. The pixel unit 10 and the liquid crystal lens unit are bonded together through an adhesive layer 14. The liquid crystal lens unit 20 and the touch sensor unit 30 are bonded together by using a driving electrode 19 to be common. The common use of the driving electrode 19 will be described later in detail. The pixel unit 10 includes a plurality of organic EL devices as display pixels. The liquid crystal lens unit 20 is a display switching function unit, and displays an image by passing light emitted from the pixel unit 10 and displays the image at that time as a 3D image or a 2D image in a switchable manner. The touch sensor unit 30 has the function of a capacitive-type touch sensor.

The pixel unit 10, for example, includes a plurality of organic EL devices configuring pixels of R (red), G (green), and B (blue) of the display device 1.

More specifically, in the pixel unit 10, for example, at least one pixel electrode layer 11a and at least one organic EL layer 12 are stacked on a first substrate 11, and a pixel common electrode 13a, which is a common electrode, is further stacked on the organic EL layer 12. In other words, in a case where there is a plurality of stacked bodies of the pixel electrode layer 11a and the organic EL layer 12, the pixel common electrode 13a is disposed in each stacked body as a common opposing electrode. In addition, the pixel common electrode 13a is sealed by disposing a second substrate 13 thereon.

The first substrate 11 is a circuit board that is used for driving the pixel unit 10, and a pixel driving unit 71 (not illustrated in the figure) driving a pixel is disposed on the first substrate 11. The pixel driving unit 71 is configured by a pixel transistor and a peripheral circuit. As the pixel transistor, for example, there is a thin film transistor or the like.

While the pixel electrode layer 11a is not particularly limited as long as it has a function of an anode injecting holes into the organic EL layer 12, it is preferable that the pixel electrode layer 11a have a function of a light reflecting layer reflecting the organic EL layer 12. The pixel electrode layer 11a, for example, is configured by a plurality of pixel electrodes disposed for each pixel transistor described above. While a material forming the pixel electrode layer 11a is not particularly limited as long as it is a material having high conductivity, in a case where the pixel electrode layer 11a serves as the light reflecting layer, it is preferable that the pixel electrode layer 11a formed by using a material having high light reflectivity, and more particularly, high reflectance of visible light be used. As a material forming the pixel electrode layer 11a, for example, there is a metal material, a conductive oxide, or the like. As metal, for example, there is a material containing at least one type of metal selected from a group composed of gold (Au), platinum (Pt), silver (Ag), titanium (Ti), aluminum (Al), ruthenium (Ru), molybdenum (Mo), copper (Cu), zinc (Zn), tin (Sn), zirconium (Zr), tungsten (W), and nickel (Ni), or the like. As the material containing the above-described metal, there is a simple substance, a compound, an alloy, or the like, and, as the alloy, for example, an alloy having Al as its principal component such as an AlNd alloy or an AlCe alloy is preferable. As the conductive oxide, for example, there is a material having zinc oxide (ZnO), indium oxide (In₂O₃), tin oxide (SnO₂), gallium oxide (Ga₂O₃), tellurium oxide (TeO₂), germanium oxide (GeO₂), cadmium oxide (CdO), tungsten oxide (WO₃), molybdenum oxide (MoO₃), CuAlO₂, LaCuOS, LaCuOSe, SrCu₂O₂, NiO, or the like as its base material. As Ga₂O₃, beta-Ga₂O₃ having the most stable structure is preferable. As a material having ZnO as its base material, for example, there is AZO, GZO, IZO (Indium Zinc Oxide), FZO, or the like. In addition, as a material having In₂O₃ as its base material, for example, there is ITO, FTO, or the like. In addition, as a material having SiO₂ as its base material, there is ATO or the like. Furthermore, the pixel electrode layer 11a, for example, may be configured by a single film of a magnesium-silver (Mg—Ag) codeposition film or a stacked film thereof. On the pixel electrode layer 11a, for example, a pixel separating film (not illustrated in the figure) having openings corresponding to each pixel electrode is disposed, and a light emitting area is partitioned for each pixel.

While the organic EL layer 12 is not particularly limited as long as it is an organic electric field light emitting layer that emits light based on recombination of holes and electrons, for example, there is a white light emitting layer emitting white light that is disposed to be common to pixels, a light emitting layer of each color (red, green, and blue) disposed for each pixel, or the like.

In a case where the organic EL layer 12 is configured using the white light emitting layer, by arranging a color filter for each pixel, light of red, green, and blue can be drawn.

The pixel common electrode 13a is an electrode that is common to the pixels and is not particularly limited as long as it has the function of a cathode injecting electrons into the organic EL layer 12, and it is preferable that the pixel common electrode 13a have light permeability, and more particularly, visible light permeability. In addition, it is preferable that the pixel common electrode 13a be disposed in at least a part of the organic EL layer 12. While a material forming the pixel common electrode 13a is not particularly limited as long as it has a high conductivity, it is preferable that the material be a transparent conductive material having high light permeability, particularly, visible light permeability. As the transparent conductive material, for example, there is a transparent conductive oxide or the like. As the conductive oxide, for example, there is a material having zinc oxide (ZnO), indium oxide (In₂O₃), tin oxide (SnO₂), gallium oxide (Ga₂O₃), tellurium oxide (TeO₂), germanium oxide (GeO₂), cadmium oxide (CdO), tungsten oxide (WO₃), molybdenum oxide (MoO₃), CuAlO₂, LaCuOS, LaCuOSe, SrCu₂O₂, NiO, or the like as its base material. As Ga₂O₃, beta-Ga₂O₃ having the most stable structure is preferable. As a material having ZnO as its base material, for example, there is AZO, GZO, IZO (Indium Zinc Oxide), FZO, or the like. In addition, as a material having In₂O₃ as its base material, for example, there is ITO, FTO, or the like. In addition, as a material having SiO₂ as its base material, there is ATO or the like. In addition, the pixel common electrode 13a, for example, may be configured by a single film of a magnesium-silver (Mg—Ag) codeposition film or a stacked film thereof.

Between the pixel electrode layer 11a and the organic EL layer 12, for example, a hole injecting layer (not illustrated in the figure), a hole transport layer (not illustrated in the figure), and the like may be disposed. In addition, between the pixel common electrode 13a and the organic EL layer 12, for example, an electron injecting layer (not illustrated in the figure), an electron transport layer (not illustrated in the figure), and the like may be disposed. Furthermore, on the pixel common electrode 13a, for example, a color filter layer, a black matrix layer, and the like may be disposed.

While the second substrate 13 is not particularly limited as long as it has the function of sealing the pixel unit 10, it is preferable that the second substrate 13 be a transparent substrate formed using a transparent material having light permeability, particularly, visible light permeability. As a transparent material forming the transparent substrate, for example, there is a transparent inorganic material, a transparent resin material, or the like. As the transparent inorganic material, for example, there is quartz glass, borosilicate glass, phosphate glass, soda glass, or the like. As the transparent resin material, for example, there is polyethylene terephthalate (PET), polyethylene naphthalate (PEN), polybutylene terephthalate (PBT), acetylcellulose, tetra-acetylcellulose, polyphenylene sulfide, polycarbonate (PC), polyethylene (PE), polyprophylene (PP), polyvinylidene fluoride, phenoxy bromide, amides, polyimides such as polyether imide, polystyrenes, polyarylates, polysulphones such as polyesther sulphone, or polyolefins, or the like. In addition, the substrate 13 may be formed by using at least one type of material or two or more types of material selected from a group composed of the above-described materials. As a specific material formed by two or more types of material, there is a stacked body.

The liquid crystal lens unit 20 displays an image by passing light emitted from the pixel unit 10 and has a display switching function for displaying an image as a 3D image or a 2D image in a switchable manner.

More specifically, the liquid crystal lens unit 20 has a configuration in which a liquid crystal layer 18 is sealed between an opposing electrode 16 disposed on the face of a third substrate 15 and the driving electrode 19 disposed on the face of a protection layer 21. The liquid crystal lens unit 20 is a focus-variable lens of which the focal position moves as the refractive index thereof changes in accordance with a voltage applied to the liquid crystal layer 18. In accordance with the change in the refractive index according to the applied voltage, switching between a 3D display and a 2D display is performed. On an opposing electrode 16-side face out of faces facing each other, a first alignment film 17a is formed, and, on a driving electrode 19-side face thereof, an alignment film 17b is formed. The alignment film 17b may be formed as a film having a face along concavity and convexity formed by the driving electrode 19 or may be formed as a flat film so as to embed the concavity and convexity formed by the driving electrode 19.

An adhesive layer 14 is not particularly limited as long as it has a configuration in which the second substrate 13 and the third substrate 15 can be bonded together, and it is preferable that the adhesive layer 14 be a transparent adhesive formed using a transparent material having light permeability, and more particularly, visible light permeability or the like. As the transparent adhesive, for example, one can be selected from among the above-described transparent resin materials, and more particularly, there is an acrylic adhesive, an epoxy adhesive, a urethane adhesive, or the like.

The third substrate 15 is not particularly limited as long as it is a substrate for forming the liquid crystal lens unit 20, and it is preferable that the third substrate 15 be a transparent substrate formed using a transparent material having light permeability, and more particularly, visible light permeability and may be configured by appropriately selecting a transparent material described above.

An opposing electrode 16 is not particularly limited as long as it is an electrode having a function for applying a driving voltage to the liquid crystal lens unit 20 and/or the touch sensor unit 30 by being combined with a driving electrode 19, and it is preferable that the opposing electrode 16 be a transparent electrode having light permeability, and more particularly, visible light permeability. More specifically, for example, it is preferable that the opposing electrode 16 be disposed in at least a part of a face opposite to a face with which the adhesive layer 14 of the third substrate 15 is brought into contact and is preferably disposed on the whole face. A material forming the opposing electrode 16 is not particularly limited as long as it is a material having conductivity, and it is preferable that the material have light permeability, and more particularly, visible light permeability. A material forming the opposing electrode 16, for example, may be appropriately selected from among the above-described materials as transparent conductive materials. In addition, the opposing electrode 16, for example, may be connected to a common electric potential line or the like maintained at fixed electric potential (common electric potential) or may be grounded.

As the liquid crystal of the liquid crystal layer 18, a liquid crystal that is generally known can be appropriately selected, and, for example, a liquid crystal formed by nematic liquid crystal or the like and having homogeneous alignment is preferable. In addition, the alignment films 17a and 17b are not particularly limited, as long as they control the alignment state of the liquid crystal in the liquid crystal layer 18 and, for example, are formed by polyimide or the like.

The driving electrode 19 is not particularly limited, as long as it is an electrode having a function for applying a drive voltage to the liquid crystal layer 18 by being combined with the opposing electrode 16 and is preferably a transparent electrode having light permeability, and more particularly, visible light permeability. A material forming the driving electrode 19 is not particularly limited, as long as it is a material having conductivity, and it is preferable that the material be a material having high light transmissivity. As a material forming the driving electrode 19, for example, a material described above as a transparent conductive material can be appropriately selected.

The shape of the driving electrode 19 is not particularly limited and, for example, is preferably an elongated shape extending to be parallel to one side of the display device 1. More specifically, as the elongated shape, for example, there is a pillar shape. The pillar shape is not particularly limited, and it is preferable that at least one face of the side faces of the pillar shape have a flat shape. More specifically, as the pillar shape, for example, there is n-angle pillar (here, n is equal to or greater than 3), a semi-cylinder, a rectangular parallelepiped, or a cube. Among such shapes, a right cylinder shape such as a rectangular parallelepiped is preferable.

While the installation form of the driving electrode 19 is not particularly limited as long as the driving electrode 19 is disposed in at least a part of the liquid crystal layer 18 through the alignment film 17b, it is preferable that the driving electrode 19 be disposed in at least a part of the face of the protection layer 21. Toward the upper side of the protection layer 21, for example, it is preferable that the driving electrode 19 have a face parallel to the principal face of the fourth substrate 23 and is disposed so as to extend to be parallel to one side of the fourth substrate 23. In addition, on the face of the protection layer 21, it is preferable that a plurality of the driving electrodes 19 be arranged in parallel with a constant space. At this time, as the shape of the driving electrode 19, the above-described pillar shape can be appropriately selected, and it is preferable that a face parallel to the principal face of the fourth substrate 23 be a strip shape. The alignment film 17b is disposed on the face of the protection layer 21 so as to cover the plurality of the driving electrodes 19.

The touch sensor unit 30 is not particularly limited as long as it has a function for detecting whether an object is in contact or in proximity thereto and is preferably a capacitive-type touch sensor. In such a case, the object, for example, is a finger, a stylus, or the like. The capacitive-type touch sensor, for example, is configured by a capacitor between the driving electrode and the detection electrode.

In the touch sensor unit 30, for example, the driving electrode 19 of the liquid crystal lens unit 20 may be used as the driving electrode of the touch sensor unit 30. At this time, the touch sensor unit 30 is configured such that the protection layer 21, which is a dielectric, is disposed between the driving electrode 19 and the detection electrode 22 so as to be in contact therewith and is sealed by the fourth substrate 23 disposed on the detection electrode 22. From this, the driving electrode 19 has two constituent elements including a constituent element as the driving electrode of the liquid crystal lens unit 20 and a constituent element also as the driving electrode of the touch sensor unit 30.

The detection electrode 22 is not particularly limited as long as it is an electrode that can form a capacitor with the driving electrode 19 and the protection layer 21, and it is preferable that the detection electrode 22 be a transparent electrode having light permeability, and more particularly, visible light permeability. For example, the detection electrode 22 can be configured by appropriately selecting the material described above as a transparent conductive material.

The shape of the detection electrode 22 is not particularly limited and, for example, is preferably an elongated shape extending to be parallel to one side of the display device 1. More specifically, as the elongated shape, for example, there is a pillar shape. As the pillar shape, a shape described above as the shape of the driving electrode may be appropriately selected.

The detection electrode 22 is not particularly limited as long as it is disposed in at least a part of the driving electrode 19 through the protection layer 21, and it is preferable that the detection electrode 22 be disposed in at least a part of the face of the fourth substrate 23. In addition, it is preferable that the detection electrode 22 be disposed in a form intersecting the driving electrode 19, and it is more preferable that the detection electrode 22 be disposed in a form perpendicular to the driving electrode 19. In a case where the detection electrode 22 is disposed on the fourth substrate 23, for example, it is preferable that the detection electrode 22 have a face parallel to the principal face of the fourth substrate 23 and is disposed so as to extend to be parallel to one side, which is perpendicular to the driving electrode 19, out of sides of the principal face of the fourth substrate 23. At this time, while the pillar shape described above may be appropriately selected as the shape of the detection electrode 22, it is preferable that a face parallel to the principal face of the fourth substrate 23 have a strip shape.

The protection layer 21 is not particularly limited as long as it is disposed in at least a part of a space between the driving electrode 19 and the detection electrode 22, and it is preferable that the protection layer 21 be disposed in all the space between the driving electrode 19 and the detection electrode 22. A material configuring the protection layer 21 is not particularly limited as long as it is one of dielectric materials that are generally known or contains at least one thereof, it is preferable that the protection layer 21 be made of a transparent material having high visible light transmissivity. More specifically, the transparent material, for example, may be appropriately selected from among the materials described above as transparent materials and is preferably a transparent resin material from them. Among the transparent resin materials, a material is preferable, which is a liquid or a viscous body at room temperature and is cured to be solidified at room temperature. In addition, the protection layer 21 may be a thin film formed from an inorganic material. As the inorganic material, for example, there is SiN, SiON, SiO2, or the like.

The fourth substrate 23 is not particularly limited as long as it has a function for sealing the touch sensor unit 30, and it is preferable that the fourth substrate 23 be a transparent substrate formed using a transparent material having light permeability, and more particularly, visible light permeability. The transparent substrate can be configured by appropriately selecting the above-described material as the transparent material. As the fourth substrate 23 seals the touch sensor unit 30, the liquid crystal lens unit 20 is sealed as well. From this, the touch sensor unit 30 configures a part of the liquid crystal lens unit 20.

In addition, a polarizing plate 24 is bonded to the upper side of the fourth substrate 23. The polarizing plate 24 may be a circular polarizing plate. Here, in light emitted from the pixel unit 10, two types of polarized light are included, polarized light of one type is influenced by the birefringence effect of the liquid crystal lens unit 20, and polarized light of the other type is output without being influenced by the effect thereof. Accordingly, the polarized light that is not influenced by the birefringence effect in the liquid crystal lens unit 20 is eliminated by the polarizing plate 24. In addition, the reflection of external light can be eliminated by the polarizing plate 24.

Next, the connection form of the control unit 70, the pixel driving unit 71, the driving circuit 72 of the liquid crystal lens unit and the touch sensor unit, and the detection circuit 73 will be described. The connection form to the display device 1 is basically the same as the connection form to a portion (the control unit 170 to the detection circuit 173) corresponding to the above-described display device 100. Here, especially, the connection form of the display device 1 and the driving circuit 72 of the liquid crystal lens unit and the touch sensor unit, and the detection circuit 73 will be described in detail.

The driving circuit 72 of the liquid crystal lens unit and the touch sensor unit applies predetermined drive signals to the liquid crystal lens unit 20 and the touch sensor unit 30 based on a control signal supplied from the control unit 70. The drive signals are applied to the driving electrode 19. In this embodiment, as described above, although the driving electrode 19 is commonly used by the liquid crystal lens unit 20 and the touch sensor unit 30, a drive signal for the liquid crystal lens unit 20 and a drive signal for the touch sensor unit 30 are separately set. For example, the driving circuit 72 of the liquid crystal lens unit and the touch sensor unit applies mutually-different AC signals having rectangular waveforms to the driving electrode 19 at mutually-different timings.

FIG. 2 schematically illustrates an example of the driving circuit 72 of the liquid crystal lens unit and the touch sensor unit and the detection circuit 73 together with the layout of the driving electrode 19 and the detection electrode 22. The layout of the driving electrode 19 and the detection electrode 22 is seen from the detection electrode 22 side.

As illustrated in FIG. 2, the driving electrode 19 is configured by a plurality of driving electrodes 19(1) to 19(n) having an elongated shape extending in one direction. The detection electrode 22 is configured by a plurality of detection electrodes 22(1) and 22(p) having an elongated shape extending in parallel in a direction intersecting the plurality of driving electrodes 19(1) to 19(n). In this case, the plurality of detection electrodes 22(1) to 22(p) have an elongated shape extending in parallel in a direction perpendicular to the plurality of driving electrodes 19(1) to 19(n).

Regarding the plurality of driving electrodes 19(1) to 19(n), for example, the plurality of driving electrodes 19(1) to 19(n) are disposed to be electrically separated from each other. The plurality of driving electrodes 19(1) to 19(n), for example, are preferably disposed in parallel at intervals and are more preferably disposed at a constant interval. In addition, at least two driving electrodes out of the plurality of driving electrodes 19(1) to 19(n) may be electrically connected to each other, and, in such a case, a plurality of driving electrodes connected together may have a shape (comb-teeth shape) in which end portions thereof are connected. A drive signal may be applied to the plurality of driving electrodes connected together as one set of unit driving lines. In addition, in a case where the plurality of driving electrodes 19(1) to 19(n) are disposed to be electrically separated, a drive signal can be applied to each driving electrode.

Regarding the plurality of detection electrodes 22(1) to 22(p), for example, the plurality of detection electrodes 22(1) to 22(p) are disposed to be electrically separated from each other. The plurality of detection electrodes 22(1) to 22(p), for example, are preferably disposed in parallel at intervals and are more preferably disposed at a constant interval. In addition, at least two detection electrodes out of the plurality of detection electrodes 22(1) to 22(p) may be electrically connected to each other, and, in such a case, a plurality of detection electrodes 22(1) and 22(p) connected together may have a shape (comb-teeth shape) in which end portions thereof are connected. A detection signal may be applied to the plurality of detection electrodes 22(1) to 22(p) connected together as one set of unit detection lines. In addition, in a case where the plurality of detection electrodes 22(1) to 22(p) are disposed to be electrically separated, a detection signal can be acquired from each detection electrode configuring the plurality of detection electrodes 22(1) to 22(p).

As described above, by disposing the detection electrode 22 and the driving electrode 19 to intersect each other, in an intersection thereof, a structure is formed in which the protection layer 21 is vertically sandwiched between the detection electrode 22 and the driving electrode 19. From this, a capacitor is formed in the intersection between the detection electrode 22 and the driving electrode 19. In addition, a plurality of intersections between the detection electrode 22 and the driving electrode 19 are disposed. From this, the intersections are formed in a matrix pattern, and the location of an object can be detected as 2D coordinates. Furthermore, it can be detected whether there is a touch made by a plurality of persons and a plurality of fingers, that is, a so-called multi-touch or the like.

The driving circuit 72 of the liquid crystal lens unit and the touch sensor unit applies a drive signal Vs to the plurality of driving electrodes 19(1) to 19(n) as described above, for example, in a line-sequential manner. At this time, the drive signal Vs may be applied to one driving electrode or may be applied to the above-described one set of unit driving lines. The driving circuit 72 of the liquid crystal lens unit and the touch sensor unit, for example, includes a shift register 721, a selection unit 722, a level shifter 723, and a buffer 724.

The shift register 721 is a logical circuit that is used for sequentially transferring input pulses. The selection unit 722 is a logical circuit that controls whether or not drive signals (Vd and Vs) are output to each display pixel disposed within the effective display area 200 and controls the output of the drive signals (Vd and Vs) in accordance with the position within the effective display area 200 or the like. The level shifter 723 is a circuit that is used for shifting a control signal supplied from the selection unit 722 to an electric potential level that is sufficient for controlling the drive signals (Vd and Vs). The buffer 724 is a final output logical circuit used for sequentially applying the drive signal Vs to each line and, for example, includes an output buffer circuit, a switch circuit, or the like.

The drive signal Vs is applied from the driving circuit 72 of the liquid lens unit and the touch sensor unit to the driving electrode 19. From this, a detection signal Vdet that is based on the capacitance can be acquired from the detection electrode 22. The detection signal acquired in this way is sent to the detection circuit 73.

FIG. 3 illustrates a functional block configuration of the detection circuit 73 performing an object detecting operation and a timing control unit 74 as a timing generator. Here, capacitors Cn1 to Cnp correspond to capacitors formed at the intersections between the plurality of driving electrodes 19(1) to 19(n) and the plurality of detection electrodes 22(1) to 22(p). Such capacitors Cn1 to Cnp are connected to drive signal sources S used for supplying the drive signal Vs.

The detection circuit 73 is not particularly limited, and, as the detection circuit 73, for example, there is a voltage detector, a current detector, or the like. The detection circuit 73, for example, includes an amplifier unit 81, an AD conversion unit 83, a signal processing unit 84, a frame memory 86, a coordinate extracting unit 85, and a resistor R. An input terminal Tin of the detection circuit 73 is commonly connected to the other side of the capacitors Cn1 to Cnp, in other words, the detection electrode 22 side.

The amplifier unit 81 amplifies the detection signal Vdet input from the input terminal Tin and, for example, includes an operational amplifier used for signal amplification, a capacitor, and the like. The resistor R is arranged between the amplifier unit 81 and the ground. This resistor R is used for maintaining a stable state by avoiding a floating state of the detection electrode 22. From this, in the detection circuit 73, it is avoided that the signal value of the detection signal Vdet unsteadily changes, and there is an advantage that the static electricity can be grounded through the resistor R.

The AD conversion unit 83 is a part converting the analog detection signal Vdet amplified by the amplifier unit 81 into a digital detection signal and is configured to include a comparator not illustrated in the figure. This comparator compares the electric potential of an input detection signal and the electric potential of a predetermined threshold voltage Vth with each other. The sampling timing at the time of AD conversion in the AD conversion unit 83 is controlled in accordance with a timing control signal CTL2 supplied from the timing control unit 74.

The signal processing unit 84 performs predetermined signal processing for the digital detection signal output from the AD conversion unit 83. As this signal processing, for example, there is signal processing such as a noise eliminating process using a digital technique or a process of converting frequency information into position information.

The coordinate extracting unit 85 determines whether there is an object based on a detection signal output from the signal processing unit 84. In a case where there is an object, the coordinate extracting unit 85 acquires the coordinates of the object and outputs the coordinates from an output terminal Tout as a detection signal Dout that is a detection result.

A place at which the detection circuit 73 is formed is not particularly limited, and the detection circuit 73 may be formed on the periphery of the display area such as a position on the protection layer 21, the fourth substrate 23, or the first substrate 11. Particularly, in a case where the detection circuit 73 is formed on the first substrate 11, integration with a pixel driving driver formed on the first substrate 11 in advance or the like is achieved, which is desirable from the aspect of simplification through integration.

<Method of Manufacturing Display Device>

First, a pixel unit 10, which is an organic EL light emitting device, is formed by using a method that is generally known. The method of forming the pixel unit 10 is not particularly limited, and, for example, the pixel unit 10 can be manufactured as follows. First, a pixel electrode layer 11a that is an anode is formed on a first substrate 11, and, on the pixel electrode layer 11a, an organic EL layer that is a light emitting layer and a pixel common electrode 13a that is a cathode are formed in a stacked manner. Finally, the pixel unit 10 is sealed by using a second substrate that is a sealing substrate. In this way, the pixel unit 10 is formed.

Next, a liquid crystal lens unit 20 and a touch sensor unit 30 that commonly use a driving electrode 19 are formed. The method of forming the liquid crystal lens unit 20 and the touch sensor unit 30 that commonly use the driving electrode 19 is not particularly limited, and, for example, the liquid crystal lens unit 20 and the touch sensor unit 30 can be formed as follows.

First, by performing etching or the like of a fourth substrate 23 having a transparent conductive layer on the principal face, the fourth substrate 23 including a plurality of detection electrodes 22 disposed on the principal face at a constant interval is formed. Next, the upper side of the detection electrode 22 is coated with a liquid transparent resin having hardenability so as to cover the detection electrode 22 and form a flat film in which the whole coated face is flat, whereby a protection layer 21 is formed. After the transparent resin is cured, driving electrodes 19 are formed on the face of the transparent resin film that is a protection layer 21 so as to be arranged at a constant interval in a direction perpendicular to the detection electrode 22. The driving electrodes 19, for example, are formed by forming a transparent conductive layer on the whole principal face of the protection layer 21 and performing etching or the like. At this time, the protection layer 21 is formed by using a vacuum vapor deposition method, a sputtering method, a CVD method, or the like. After the driving electrodes 19 are formed on the protection layer 21, an alignment film 17b is formed on the surface of the driving electrodes 19. The alignment film 17b is formed also on the protection layer 21 as is necessary. Next, a polarizing plate 24 is formed on a face located on a side opposite to the face on which the detection electrodes 22 of the fourth substrate 23 are disposed. In this way, the touch sensor unit 30 is formed.

Next, an opposing electrode 16 and an alignment film 17a are formed by being sequentially stacked on a third substrate 15 that is an opposing electrode substrate. Next, on the third substrate 15 having the opposing electrode 16 and the alignment film 17a on the surface thereof, for example, spacers or the like are disposed, and liquid crystal is dropped, whereby a liquid crystal layer 18 is formed. Next, by bonding the upper side of the liquid crystal layer 18 and a face of the touch sensor unit 30, which is on the driving electrode 19 side, the liquid crystal layer 18 is sealed. In this way, a liquid crystal lens unit 20 including the touch sensor unit 30 is formed.

Next, the pixel unit 10 and the liquid crystal lens unit 20 including the touch sensor unit 30 are integrally formed by bonding the second substrate 13 and the third substrate 15 through an adhesive layer 14. To each electrode of the stacked body including the pixel unit 10 and the liquid crystal lens unit 20 including the touch sensor unit 30, the pixel driving unit 71, the driving circuit 72 of the liquid crystal lens unit and the touch sensor unit, and the detection circuit 73 are connected. In addition, a control unit 70 is connected to such a circuit. In this way, a target display device 1 is completed.

<Operation of Display Device>

Next, a pixel driving operation in the display device 1 will be described. The operation of this display device 1 is basically similar to the operation of the display device 100. More specifically, in this display device 1, when a video signal S is input from the control unit 70 to the pixel driving unit 71, a scanning line-power source line driving circuit 75 and a signal line driving circuit 76 drive pixels within an effective display area for a display. The scanning line-power source line driving circuit 75 and the signal line driving circuit 76 have configurations similar to those of the scanning line-power source line driving circuit 175 and the signal line driving circuit 176 of the display device 100. From this, a drive current flows through an organic EL device within each pixel, and, for example, holes and electrons are recombined in the organic EL layer 12 so as to emit white light. Light emitted from the pixel unit 10 is sequentially transmitted through the second substrate 13, the adhesive layer 14, and the third substrate 15 and then is incident to the liquid crystal lens unit 20.

Next, a display switching operation, a 3D image displaying operation, and a 2D image displaying will be described. As described above, light incident from the pixel unit 10 to the liquid crystal lens unit 20 is displayed as an image by passing through the liquid crystal lens unit 20. At this time, in the liquid crystal lens unit 20, a drive signal Vd is applied to the driving electrode 19. A voltage corresponding to the drive signal Vd is applied to the liquid crystal layer 18 disposed at a position sandwiched between the driving electrode 19 and the opposing electrode 16. From this, the liquid crystal lens unit 20 is driven. More specifically, for example, the alignment state of liquid crystal molecules dispersing inside the liquid crystal layer 18 changes, and an image that is based on light incident from the pixel unit 10 is displayed as a 3D image or a 2D image in a switchable manner.

Next, an image displaying operation in the liquid crystal lens unit 20 and an object detecting operation in the touch sensor unit 30 will be described.

FIG. 4A illustrates an example of the waveform of a drive signal used for a 3D display that is applied to the driving electrode 19 at the time of a 3D display, and FIG. 7B illustrates an example of the waveform of a drive signal used for a 2D display that is applied to the driving electrode 19 at the time of a 2D display.

As illustrated in FIG. 4A, at the time of a 3D display, a drive signal applied to the driving electrode 19, for example, is a composite signal in which a drive signal used for driving the touch sensor unit 30 overlaps a drive signal used for driving the liquid crystal lens unit 20. This drive signal is applied from driving circuit 72 of the liquid crystal lens unit and the touch sensor unit to the driving electrode 19 based on a control instruction supplied from the control unit 70.

In a case where a 3D image display is performed, a drive signal used for driving the liquid crystal lens unit 20, for example, is an AC rectangular wave signal or the like. More specifically, this AC rectangular wave signal is a drive signal Vd1 of which the polarity is inverted at the cycle of one frame period. When a case is considered in which this drive signal Vd1 is applied to the driving electrode 19, the same drive signal Vd1 is applied to all the plurality of driving electrodes 19(1) to 19(n) configuring the driving electrode 19 at the same timing. In addition, the drive signal Vs used for driving the touch sensor unit 30 is applied to the drive signal Vd1 in an overlapping manner. The drive signal Vs used for driving the touch sensor unit 30 will be described later in detail.

As illustrated in FIG. 4B, at the time of a 2D display, a drive signal applied to the driving electrode 19 is a composite signal similar to the drive signal at the time of a 3D display. This drive signal, similarly to the time of a 3D display, is applied to the driving electrode 19. In addition, the drive signal Vs used for driving the touch sensor unit 30 is applied also to the drive signal Vd2 in an overlapping manner.

In a case where a 2D image display is performed, a drive signal used for driving the liquid crystal lens unit 20, for example, is an AC rectangular wave similar to the drive signal at the time of a 3D display or the like. More specifically, for example, this AC rectangular wave signal is a drive signal Vd2 other than the above-described drive signal Vd1 of which the polarity is inverted at the cycle of one frame period. Here, Vd1>Vd2. When a case is considered in which this drive signal Vd2 is applied to the driving electrode 19, similarly to the case of the 3D display, the same drive signal Vd2 is applied to all the plurality of driving electrodes 19(1) to 19(n) at the same timing.

The frequencies of the drive signals Vd1 and Vd2 are not particularly limited and, for example, the AC rectangular waveforms of the drive signals Vd1 and Vd2 and the magnitude relation thereof can be appropriately set in accordance with the characteristics of the liquid crystal used in the liquid crystal layer 18, the thickness of the liquid crystal layer 18, and the scale of inter-electrode slits in the driving electrode 19, and the like.

FIG. 5A illustrates a guided wave optical path of light that is incident from the pixel unit 10 to the liquid crystal lens unit 20 at the time of a 3D display and is emitted from the polarizing plate 24 to the outside. FIG. 5B illustrates a guided wave optical path of light that is incident from the pixel unit 10 to the liquid crystal lens unit 20 at the time of a 2D display and is emitted from the polarizing plate 24 to the outside.

As illustrated in FIG. 5A, for example, when the drive signal Vd1 is applied to the driving electrode 19, the alignment of liquid crystal molecules is inclined with respect to incident light as illustrated in the figure. Accordingly, the light incident from the pixel unit 10 side to the liquid crystal lens unit 20 is refracted in the process of passing the liquid crystal layer 18 and is output in a plurality of mutually-different angular directions. From this, an image that is based on the light emitted from the pixel unit 10 is split and projected to the left and right eyes by the liquid crystal lens unit 20. At this time, in a case where an image that is based on the light emitted from the pixel unit 10 is a composite image of left and right parallax images, the image is displayed as a 3D image and is visually perceived as a 3D image by a person seeing the image.

On the other hand, as illustrated in FIG. 5B, for example, when the drive signal Vd2 is applied to the driving electrode 19, the alignment of liquid crystal molecules is parallel to the incident light as illustrated in the figure. Accordingly, the light emitted from the pixel unit 10 side is output to the liquid crystal lens unit 20 without refracting in the liquid crystal layer 18.

Accordingly, an image that is based on the light emitted from the pixel unit 10 is displayed as a 2D image on the polarizing plate 24 and is visually perceived as a 2D image by a person seeing the image.

In the drive signal applied to the driving electrode 19, the drive signal Vs used for driving the touch sensor unit 30 is included. Accordingly, in the display device 1, together with the image displaying operation described above, by driving the touch sensor unit 30, it can be detected whether an object is in contact with or in proximity to the polarizing plate 24.

In the driving of the touch sensor unit 30, for example, the drive signal Vs of the touch sensor unit 30 is applied together with the drive signal of the liquid crystal lens unit 20 from the driving circuit 72 of the liquid crystal lens unit and the touch sensor unit to the driving electrode 19 in an overlapping manner. As the drive signal Vs, for example, a rectangular wave having a constant period may be used. When a case is considered in which the drive signal Vs is applied to the driving electrode 19, the same drive signal Vs is sequentially applied to all the plurality of driving electrodes 19(1) to 19(n) configuring the driving electrode 19 with being shifted by a constant time in the time axis direction.

In addition, it is preferable that the application time of the drive signal Vs of the touch sensor unit 30 be much shorter than the application time of the drive signals Vd1 and/or Vd2 of the liquid crystal lens.

The drive signal Vs of the touch sensor unit 30 may be applied in the blanking periods of the drive signals Vd1 and/or Vd2. Accordingly, an object can be detected with hardly influencing on the image displaying operation in the liquid crystal lens unit 20. The reason for this is that the application time of the drive signal of the touch sensor unit 30 is much shorter than the application time of the drive signal of the liquid crystal lens unit 20, and accordingly, the drive signal of the touch sensor unit 30 does not cause the liquid crystal layer 18 to respond thereto to a level at which the drive signal of the touch sensor unit 30 has influence on the display.

Next, the principle of the object detecting operation will be described in detail.

FIGS. 6 to 9 are schematic diagrams that illustrate the principle of the object detecting operation.

FIG. 6A is a diagram that illustrates the touch sensor unit 30 in a simplified manner.

FIG. 6B is an equivalent circuit diagram of the configuration illustrated in FIG. 6A.

FIG. 7 is an outlines line drawing that illustrates an example of a detection signal

Vdet appearing in the detection electrode 22 in a case where a predetermined drive signal Sg is applied to the driving electrode 19. FIG. 7B illustrates an example of the waveform of the drive signal Sg applied to the driving electrode 19, and FIG. 7A illustrates an example of the waveform of the detection signal Vdet appearing in the detection electrode 22.

As illustrated in FIG. 6A, by disposing a protection layer 21, which is a dielectric, between the driving electrode 19 and the detection electrode 22 arranged to face each other, a capacitor C1 is formed. The drive signal Sg is applied to the driving electrode 19 from the outside. As illustrated in FIG. 6B, one end P of the capacitor C1 is connected to an AC signal source S that is a drive signal source. In addition, the other end Q of the capacitor C1 is grounded through the resistor R and is connected to a voltage detector DET that is a detection circuit 73. The drive signal Sg is applied from the AC signal source S to the one end P of the capacitor C1. In such a case, the one end P of the capacitor C1 serves as the driving electrode 19, and the other end Q serves as the detection electrode 22.

For example, when the AC rectangular wave Sg having a frequency of several kHz to several tens of kHz, as illustrated in FIG. 7B, is applied from the AC signal source S to the driving electrode 19, as illustrated in FIG. 6B, a current I0 according to the capacitance of the capacitor C1 flows in accordance with charging or discharging of the capacitor C1. In this embodiment, this AC rectangular wave Sg corresponds to the drive signal Vs. In that case, for example, the output waveform V0 of the detection signal Vdet as illustrated in FIG. 7A appears in the detection electrode 22, and this is detected by the voltage detector DET that is the detection circuit 73.

FIG. 8A is a diagram that illustrates a finger is in contact with or in proximity to the upper side of the detection electrode 22 of the touch sensor unit 30 illustrated in FIG. 7A. FIG. 8B is an equivalent circuit of the configuration illustrated in FIG. 8A. FIG. 9 is an outlines line diagram that illustrates an example of the detection signal Vdet appearing in the detection electrode 22 in a case where the drive signal Sg is applied to the driving electrode 19, and a finger or the like is in contact with or in proximity to the detection electrode 22. FIG. 9B illustrates an example of the waveform of the drive signal Sg applied to the driving electrode 19, and FIG. 9A illustrates an example of the waveform of the detection signal Vdet appearing in the detection electrode 22.

As illustrated in FIG. 8A, when a finger is in contact with or in proximity to the detection electrode 22, a capacitor C2 is formed in accordance with the contact with or the proximity to the finger. As illustrated in FIG. 8B, this is equivalent to the addition of this capacitor C2 in series to the GND side of the capacitor C1. In this state, currents I1 and 12 flow in accordance with the charging and discharging of the capacitors C1 and C2.

The waveform of the electric potential of the other end Q of the capacitor C1 at this time, for example, is a waveform V1 as illustrated in FIG. 9A, and this is detected by the voltage detector DET that is the detection circuit 73. At this time, the electric potential of a point Q is the electric potential of a divided voltage that is determined based on the currents I1 and I2 flowing through the capacitors C1 and C2. Accordingly, the waveform V1 has a value that is smaller than a waveform V0 in a non-contact state. By detecting this change in the waveform, an object such as a finger that is in contact therewith or in proximity thereto can be detected. As a method of detecting an object, for example, there is a method in which a change in the voltage value according to a change in the waveform is detected with a threshold voltage Vth being set or the like.

Here, a case will be described in which the above-described principle of the object detecting operation is applied to the driving electrode 19 according to this embodiment illustrated in FIGS. 2A an 2B. First, a protection layer 21 that is a dielectric D is disposed between a plurality of driving electrodes 19(1) to 19(n), of which the number is n, and a plurality of detection electrodes 22(1) to 22(p), of which the number is p. In that case, as the plurality of driving electrodes 19(1) to 19(n), of which the number is n, and the plurality of detection electrodes 22(1) to 22(p), of which the number is p, intersect, a capacitor C1 is formed at each intersection. Next, a drive signal Vs is applied to the plurality of driving electrodes 19(1) to 19(n), for example, in a line sequential manner, detection signals Vdet having magnitudes corresponding to capacitance values of the capacitors C1 are output from the plurality of detection electrodes 22(1) to 22(p). These output operations are performed, for example, by charging and discharging p capacitors Cn1 to Cnp formed at the intersections between one driving electrode 19 to which the drive signal Vs is applied at specific timing and the plurality of detection electrodes 22(1) to 22(p). In addition, the output operations are repeated by applying a drive signal Vs to the driving electrode 19 and scanning the drive signal Vs.

In a state in which the drive signal Vs is scanned in the driving electrode 19, when there is no user's finger or the like on the light outgoing face side of the polarizing plate 24, the magnitude of the detection signal Vdet is almost constant. On the other hand, when a user's finger or the like is in contact with or in proximity to the light outgoing face of the polarizing plate 24, a capacitor C2 according to the finger is added to the capacitor C1 formed at the contact position in advance in series on the GND side. As a result, the value of the detection signal Vdet when the drive signal Vs is applied to a driving electrode 19 corresponding to a contact position out of the plurality of driving electrodes 19(1) to 19(n) is less than that of the detection signal Vdet at another position. The detection signals Vdet acquired through the detection electrode 22 as above are output to the detection circuit 73.

The detection circuit 73 performs the object detecting operation based on the detection signals Vdet acquired as described above. For example, the detection circuit 73 performs the object detecting operation by comparing input detection signals Vdet with a predetermined threshold voltage Vth. At this time, when the value of the detection signal Vdet is the threshold voltage Vth or more, a non-contact state or a non-proximity state of the light emitting face of the polarizing plate 24 is determined. On the other hand, when the value of the detection signal Vdet is less than the threshold voltage Vth, a contact state or a proximity state of the light emitting face of the polarizing plate 24 is determined. A method of acquiring the position coordinates of the contact position of the object is not particularly limited, and, for example, a method in which the position coordinates are calculated based on a time when the drive signal Vs is applied and a time when a detection signal Vdet having a value less than the threshold voltage Vth is detected or the like may be used.

As described above, according to the first embodiment, the liquid crystal lens unit 20 is disposed on the pixel unit 10, and accordingly, an image that is based on light emitted from the pixel unit 10 can be freely displayed on a screen as a 3D image or a 2D image. In addition, since the touch sensor unit 30 is disposed on the liquid crystal layer 18 of the liquid crystal lens unit 20, it can be detected whether an object is in contact therewith or in proximity thereto together with the image display or the image switching. From this, the display device 1 enabling a user to input information while displaying a 3D image and a 2D image in a switchable manner can be acquired.

In addition, since the driving electrode of the liquid crystal lens unit 20 and the driving electrode of the touch sensor unit are configured as the common driving electrode 19, the configuration of the touch sensor unit 30 can be the configuration of the liquid crystal lens unit 20. Furthermore, the liquid crystal lens unit 20 and the touch sensor unit 30 can be driven using a drive signal acquired by composing the drive signal of the liquid crystal lens unit 20 and the drive signal of the touch sensor unit 30, and accordingly, the liquid crystal lens unit 20 and the touch sensor unit 30 can be driven by using one driving circuit. Accordingly, the display device 1 can be formed to be thinner than that of a case where the liquid crystal lens unit 20 and the touch sensor unit 30 are independently configured to be separate.

Furthermore, since the dielectric forming the touch sensor unit 30 is configured as the protection layer 21 that is formed using a transparent resin material, the productivity is improved more than a case where the dielectric is formed by a glass plate. Particularly, in a case where the protection film is formed by curing a plastic resin, the formation of patterns on both faces is not necessary, unlike a case where the glass substrate is formed by a dielectric, and accordingly, the productivity is further improved. In addition, since the dielectric can be formed to be thin, the display device 1 can be formed as a further thinner type without passing through complicated processes such as grinding performed when the glass substrate is used as the dielectric.

<2. Second Embodiment>

<Display Device>

FIG. 10 is a cross-sectional view that illustrates the configuration of the vertical cross-section of a pixel (PXL) of a display device 1 according to a second embodiment. In the following embodiments, the same reference numeral is assigned to a configuration that is the same as that of the display device 1 according to the first embodiment.

As illustrated in FIG. 10, this display device 1 has a stacked structure in which the adhesive layer 14 and the third substrate 15 of the display device 1 of the first embodiment are omitted. Accordingly, a second substrate 13 has two constituent elements including a constituent element as a sealing substrate of a pixel unit 10 and a constituent element as an opposing electrode substrate of a liquid crystal lens unit 20. The other configuration of this display device is similar to the configuration of the display device 1 of the first embodiment.

<Method of Manufacturing Display Device>

In a method of manufacturing this display device, the liquid crystal lens unit 20 is formed as below.

On the second substrate 13 sealing the pixel unit 10, an opposing electrode 16 and an alignment film 17a are formed. Next, a liquid crystal layer 18 is formed by dropping liquid crystal onto the alignment film 17a. Next, the liquid crystal layer 18 is sealed by bonding the driving electrode 19 side face of the touch sensor unit 30 on the liquid crystal layer 18. The method of manufacturing this display device is similar to that of the method of manufacturing the display device according to the first embodiment other than the description presented above.

<Operation of Display Device>

The operation of this display device is the same as that of the display device according to the first embodiment.

As described above, according to the second embodiment, in addition to the same advantages as those of the first embodiment, the number of components is decreased, whereby the display device can be realized to be further thinned.

<3. Third Embodiment>

<Display Device>

FIG. 11 is a cross-sectional view that illustrates the configuration of the vertical cross-section of a pixel (PXL) of a display device 1 according to a third embodiment.

As illustrated in FIG. 11, this display device 1 has a stacked structure in which the adhesive layer 14 and the third substrate 15 of the display device 1 of the first embodiment are omitted, and the second substrate 13 is further omitted. Accordingly, the number of substrates of the display device 1 is two of a first substrate 11 and a fourth substrate 23. Between a pixel unit 10 and a liquid crystal lens unit 20, a protection layer 25 is disposed. More specifically, the protection layer 25, for example, is disposed between a pixel common electrode 13a configuring the pixel unit 10 and an opposing electrode 16 configuring the liquid crystal lens unit 20. The protection layer 25 is not particularly limited as long as it is for sealing and protecting the pixel unit 10, and it is preferable that the protection layer 25 be thin as possibly as can. A material forming the protection layer 25 is not particularly limited as long as it is a material having electric insulation, and it is preferable that the material be a transparent material having good light permeability. As a material forming the protection layer 25, for example, the above-described material described above as the material of the protection layer 21 may be appropriately selected.

<Method of Manufacturing Display Device>

In a method of manufacturing this display device, the pixel unit 10 and the liquid crystal lens unit 20 are formed as below.

By forming a protection layer 25 on the pixel common electrode 13a, the pixel unit 10 is sealed. A method of forming the protection layer 25 is not particularly limited, and, for example, a coating method, a vapor deposition method, an MOCVD method, a sputtering method, or the like may be used. In a case where the protection layer 25 is formed by using a liquid transparent resin having hardenability, the upper side of the face of the pixel common electrode 13a is coated with the liquid transparent resin.

Next, on the protection layer 25, an opposing electrode 16 and an alignment film 17a are formed to be sequentially stacked. Next, liquid crystal is dropped onto the alignment film 17a, whereby a liquid crystal layer 18 is formed. Next, the liquid crystal layer 18 is sealed by bonding the driving electrode 19 side face of the touch sensor unit 30 on the liquid crystal layer 18. The method is similar to that of the method of manufacturing the display device according to the first embodiment other than the above-described description of the method of manufacturing the display device.

<Operation of Display Device>

The operation of this display device is the same as that of the display device according to the first embodiment.

As described above, according to the third embodiment, in addition to the same advantages as those of the first embodiment, the number of components is decreased, whereby the display device can be realized to be further thinned.

<4. Fourth Embodiment>

<Display Device>

FIG. 12 is a cross-sectional view that illustrates the configuration of the vertical cross-section of a pixel (PXL) of a display device 1 according to a fourth embodiment.

As illustrated in FIG. 12, this display device 1 has a stacked structure in which the second substrate 13, the adhesive layer 14, the third substrate 15, and the opposing electrode 16 of the display device 1 of the first embodiment are omitted. From this, the pixel common electrode 13a has three constituent elements of a constituent element as an opposing electrode of the pixel unit 10, a constituent element as an opposing electrode of the liquid crystal lens unit 20, and a constituent element as an opposing electrode of the touch sensor unit 30. In addition, a protection layer may be disposed between the alignment film 17a and the pixel common electrode 13a. The protection layer, for example, may have a configuration described above as that of the protection layer 21.

The configuration of the display device other than the above-described configuration is the same as the configuration of the display device according to the first embodiment. In addition, as another embodiment, the driving electrode of the liquid crystal lens unit 20 and the driving electrode of the touch sensor unit 30 may be separated configured, and the pixel common electrode 13a may have the above-described configuration. The configuration of the display device other than the above-described configuration is similar to that of the display device according to the first embodiment.

<Method of Manufacturing Display Device>

In a method of manufacturing this display device, the pixel unit 10 and the liquid crystal lens unit 20 are formed as below.

On the pixel common electrode 13a configuring the pixel unit 10, an alignment film 17a is formed. The alignment film 17a may be formed after a protection layer is formed on the pixel common electrode 13a, and the pixel unit 10 is sealed.

Next, a liquid crystal layer 18 is formed by dropping liquid crystal onto the alignment film 17a. Next, the liquid crystal layer 18 is sealed by bonding the driving electrode 19 side face of the touch sensor unit 30 on the liquid crystal layer 18. The method is similar to that of the method of manufacturing the display device according to the first embodiment other than the above-described description of the method of manufacturing the display device.

<Operation of Display Device>

The operation of this display device is the same as that of the display device according to the first embodiment.

As described above, according to the fourth embodiment, in addition to the same advantages as those of the first embodiment, by commonly using the pixel common electrode 13a in the pixel unit 10 and the liquid crystal lens unit 20, the number of substrates and the number of electrode layers and wirings can be decreased. From this, a simple configuration can be realized as a thin type.

<5. Fifth Embodiment>

<Display Device>

FIG. 13 is a cross-sectional view that illustrates the configuration of the vertical cross-section of a pixel (PXL) of a display device 1 according to a fifth embodiment.

As illustrated in FIG. 13, according to this display device 1, in the touch sensor unit 30 of any one of the first to fourth embodiments, driving electrodes 19 and detection electrodes 22 are alternately disposed through a protection layer 27. The side face of the driving electrode 19 and the side face of the detection electrode 22 face each other. The protection layer 27 is disposed between a fourth substrate 23 and an alignment film 17b. In addition, detection electrodes 22 disposed to face each other through the driving electrode 19 are connected using a jumper wire 26.

While the shape of the driving electrode 19 is not particularly limited, as the shape of the driving electrode 19, the above-described shape can be appropriately selected, and it is preferable that the shape be an elongated shape extending in parallel to one side of the display device 1. In addition, while the installation form of the driving electrode 19 is not particularly limited as long as a plurality of driving electrodes 19 are disposed at a constant interval, for example, in a case where the driving electrodes 19 have an elongated shape, it is preferable that the driving electrodes 19 be disposed such that longer sides thereof face each other. From this, between the driving electrodes 19 disposed to face each other, a gap portion is disposed.

While the disposition of the detection electrodes 22 is not particularly limited as long as the detection electrodes 22 are disposed at a constant interval so as not to be in contact with the driving electrodes 19 inside the gap portion, it is preferable that a gap between the side faces of the driving electrodes 19 facing each other and the side face of the detection electrode 22 be small. In addition, it is preferable that the side faces of the driving electrodes 19 facing each other and the side face of the detection electrode 22 be disposed to be parallel to each other.

In addition, it is preferable that a plurality of the detection electrodes 22 be disposed at a constant interval inside the gap portion in a direction in which the gap portion extends.

While the shape of the detection electrode 22 is not particularly limited as long as it can be disposed inside the gap portion, a shape is preferable in which side faces of the detection electrodes 22 facing the side faces of the driving electrode 19 be parallel to each other in a case where the detection electrodes are disposed inside the gap portion. More specifically, as the shape of the detection electrode 22, for example, there is a rectangular shape or the like. In addition, the size of the detection electrode 22 is not particularly limited and is preferably a size for which the detection electrodes 22 can be disposed at a constant interval in a direction in which the gap portion extends inside the gap portion.

While the disposition of the driving electrodes 19 and the detection electrodes 22 is not particularly limited as long as the driving electrodes 19 and the detection electrodes 22 are disposed such that the side faces thereof face each other without being brought into contact with each other, it is preferable that the driving electrodes 19 and the detection electrodes 22 be arranged on the same plane. In addition, it is preferable that all the driving electrodes 19 and the detection electrodes 22 be disposed on the fourth substrate 23.

While the jumper wire 26 is not particularly limited as long as it can electrically connect the detection electrodes 22 disposed to be separate from each other, it is preferable that the jumper wire 26 be disposed so as not to be in contact with the driving electrode 19. The jumper wire 26, for example, is formed around the driving electrode 19 not to be in contact therewith so as to form a bridge structure, and accordingly a structure is formed in which the driving electrodes 19 and the detection electrodes 22 are electrically independent. It is preferable that the jumper wire 26 be disposed to be in an elongated shape in a direction perpendicular to a direction in which the driving electrode 19 extends by being integrated with the detection electrode 22. In addition, as a material forming the protection layer 27, for example, the above-described material of the protection layer 21 may be appropriately selected.

In this embodiment, the bridge structure formed by the jumper wires 26 is formed on a face located on a side opposite to the fourth substrate 23 with respect to the detection electrodes 22. In this case, the plurality of detection electrodes 22 disposed to be separate from each other are connected by using the jumper wires 26. On the other hand, a bridge structure may be formed by connecting a plurality of driving electrodes 19 disposed to be separate from each other using the jumper wires 26, and, in such a case, the detection electrode 22 has a strip shape extending in a direction perpendicular to the direction in which the driving electrodes 19 are aligned. In addition, a bridge structure may be formed by disposing the driving electrodes 19 and the detection electrodes 22 to be separate from each other and connecting them by using the jumper wires.

As above, by disposing the side faces of the driving electrodes 19 and the side faces of the detection electrodes 22 to face each other, horizontal fringe capacitance is generated between the side faces facing each other. In that case, a capacitor is formed near the detection electrode 22, and an object can be detected. In order to increase the fringe capacitance, it is preferable that a gap between the side faces facing each other be small as possible as can. In addition, it is preferable that the area of the side faces facing each other be large. Furthermore, between the jumper wires 26 connecting the detection electrodes 22 and the driving electrodes 19, capacitors are formed, and accordingly, an object can be detected also in this area.

FIG. 14 is a top view that illustrates an example of the configuration of the driving electrode 19 and the detection electrodes 22 in this embodiment. In this case, a cross-section taken along line A-A in the figure is the vertical cross-section illustrated in FIG. 13.

As illustrated in FIG. 14, the driving electrode 19 has an elongated shape extending to be parallel to one side of the display device 1 and includes driving units 19a that are the driving electrodes of the liquid crystal lens unit 20 and the touch sensor unit 30, and a connection portion 19b that connects the driving units 19a. The width of the connection portion 19b is smaller than the width of the driving unit 19a, and the driving unit 19a and the connection portion 19b are alternately disposed in a direction in which the driving electrodes 19 extend. It is preferable that the driving unit 19a and the connection portion 19b be integrally formed. From this, in a longer side portion of the driving electrode 19, concave portions are formed at a constant interval in the longer side portion of the driving electrode 19. It is preferable that the concave portions be disposed on both longer sides of the driving electrode 19 so as to face each other. In addition, while it is preferable that the driving electrode have line symmetry with respect to a center line in the direction in which the driving electrodes 19 extend, the arrangement of the driving electrode 19 not limited thereto. By disposing the plurality of driving electrodes 19 at a constant interval such that the longer side portions thereof face each other, a gap portion 38 is formed between the driving electrodes 19 adjacent to each other.

While the gap portion 38 is not particularly limited as long as it is formed by the longer sides of the driving electrodes 19 adjacent to each other, it is preferable that the concave portions of the driving electrodes 19 adjacent to each other be disposed to face each other. In addition, it is preferable that the gap of the driving electrodes 19 adjacent to each other be small. In a case where the gap portion 38 is formed by the concave portions facing each other, for example, when the concave portions are rectangular concave portions, a rectangular space portion 39 is formed, and, for example, when the concave portions are semi-circle shaped concave portions, an approximately circular space portion 39 is formed.

While the disposition of the detection electrodes 22 is not particularly limited as long as the detection electrodes 22 are disposed at a constant interval so as not to be in contact with the driving electrodes 19 inside the gap portion 38, it is preferable that a gap between the side faces of the driving electrodes 19 facing each other and the side face of the detection electrode 22 inside the gap portion 38 be small. In addition, it is preferable that the side faces of the driving electrodes 19 facing each other and the side face of the detection electrode 22 be disposed to be parallel to each other. Furthermore, it is preferable that a plurality of the detection electrodes 22 be disposed inside a plurality of the gap portions 38 formed by the driving electrodes 19 adjacent to each other.

While the shape of the detection electrode 22 is not particularly limited as long as it can be disposed inside the gap portion 38, a shape is preferable in which the side faces of the detection electrode 22 facing the side faces of the driving electrode 19 be parallel to each other in a case where the detection electrode 22 is disposed inside the gap portion 38. As this shape, for example, there is a shape that is similar to the shape of the gap portion 38. For example, in a case where the shape of the gap portion 38 is a rectangular shape formed by the space portions 39 facing each other, the shape of the detection electrode 22 is also a rectangular shape, and the size of the detection electrode 22, for example is slightly smaller than that of the gap portion 38.

As above, by disposing the driving electrode 19 and the detection electrodes 22 such that the side faces thereof face each other, similarly, horizontal fringe capacitance is generated between the side faces facing each other. In addition, by forming the gap portion 38, the driving electrodes 19 can be disposed to face almost the entire face of the side faces of the detection electrode 22. From this, the area of the side faces of both electrodes facing each other is much larger than that of a case where the gap portion 38 is not formed, and accordingly, the capacitance of the formed capacitor increase to a large extent.

The configuration of this display device other than the above-described configuration is similar to the configuration of any one of the display devices according to the first to fourth embodiments.

<Method of Manufacturing Display Device>

In a method of manufacturing this display device, the liquid crystal lens unit 20 and the touch sensor unit 30 are formed as below.

First, the driving electrode 19 and the detection electrodes 22 are formed by preparing a fourth substrate 23 having a transparent conductive layer on the whole face of the principal face and patterning this transparent conductive layer through etching or the like. For the patterning, for example, a method in which an elongated transparent electrode formed in parallel at a constant interval is formed, and island-shaped transparent electrodes are formed at a constant interval interposed therebetween in the gap portion area or the like is used. At this time, the elongated transparent electrode and the island-shaped transparent electrodes are formed to be separate from each other. This elongated transparent electrode configures the driving electrode 19, and the island-shaped transparent electrodes configure the detection electrodes 22.

It is preferable that the elongated transparent electrode be patterned so as to have a plurality of concave portions facing each other at a constant interval on two sides in a direction in which the elongated shape extents. In addition, it is more preferable that the concave portions be formed to face each other, and the island-shaped transparent electrodes be patterned to be formed inside an area formed by the concave portions facing each other.

While the disposition of the island-shaped transparent electrodes is not particularly limited as long as they are disposed not to be in contact with the elongated transparent electrode in the gap portion of the elongated transparent electrode, it is preferable that the island-shaped transparent electrodes have a square shape or a rectangular shape. In addition, it is preferable that a plurality of the island-shaped transparent electrodes be formed in parallel in a direction perpendicular to the direction in which the elongated transparent electrode extends.

Next, a face of the fourth substrate on which the driving electrode 19 and the detection electrodes 22 are disposed is coated with a liquid transparent resin having hardenability to cover both electrodes so as to be a flat film, whereby a protection film is formed. Next, at least two through holes reaching up to the detection electrode 22 are formed for each detection electrode 22 at a place, which is located on the face of the protection film, having the detection electrode 22 formed on the lower side thereof. It is preferable that the through holes be formed at both ends of the area on the detection electrode 22 in a direction perpendicular to the direction in which the driving electrode 19 extends.

Next, on the face of the protection film in which the through holes are disposed, a transparent conductive layer is further formed. The transparent conductive layer is formed to connect the detection electrodes 22 that are adjacent to each other in a direction perpendicular to the direction in which the driving electrode 19 extends. This transparent conductive layer configures the jumper wires 26. While there are, for example, two detection electrodes 22 adjacent to one detection electrode 22, in this case, the jumper wires 26 are formed such that the two detection electrodes 22 are not in contact with each other, and the detection electrodes 22 are respectively connected. It is preferable that the shape of the jumper wire 26 be a rectangle having the same width as that of the detection electrode 22. By connecting a plurality of detection electrodes 22 using the jumper wires 26, the shape seen from the top of the detection electrodes 22 is a strip shape extending in the direction perpendicular to the direction in which the driving electrode 19 extends.

Next, the upper side of the face of the protection film on a side on which the jumper wires 26 are disposed is further coated with a liquid transparent resin having hard-enability. At this time, the liquid transparent resin having hardenability is coated so as to cover the jumper wires 26, and the whole coated surface is flattened so as to form the protection layer 27. Next, an alignment film 17b is formed on the protection layer 27. Subsequently, a fourth substrate 23 is prepared on a face configured by the driving electrode 19, the detection electrodes 22, and the protection layer 27, the touch sensor unit 30 is sealed, and a polarizing plate 24 is further disposed on the fourth substrate 23. In this way, the touch sensor unit 30 is formed. Other than the description presented above, the method of manufacturing a display device is the same as any one of the methods of manufacturing a display device according to the first to fourth embodiments.

<Operation of Display Device>

The operation of this display device is similar to that of the display device according to the first embodiment.

As above, according to the fifth embodiment, in addition to the same advantages as those of the first to fourth embodiments, the driving electrode 19 and the detection electrodes 22 are formed in the same layer, whereby the display device can be realized to be further thinned.

<6. Sixth Embodiment>

<Display Device>

FIG. 15 is a cross-sectional view that illustrates the configuration of the vertical cross-section of a pixel (PXL) of a display device 1 according to a sixth embodiment. FIG. 16 is a top view that illustrates an example of the configuration of driving electrodes 19 and detection electrodes 22 of a pixel (PXL) of a display device 1 according to the sixth embodiment. FIG. 15 is a cross-sectional view that illustrates the configuration of a vertical cross-section taken along line B-B illustrated in FIG. 16.

As illustrated in FIGS. 15 and 16, while the display device 1 according to this another example has the same configuration as that of the display device 1 according to the fifth embodiment, jumper wires 26 connecting detection electrodes 22 disposed to be separate from each other are formed on a face on a side opposite to an alignment film 17b with respect to the detection electrodes 22. The configuration of this display device other than the description presented above is the same as that of the display device according to the fifth embodiment.

<Method of Manufacturing Display Device>

In a method of manufacturing the display device according to the sixth embodiment, the liquid crystal lens unit 20 and the touch sensor unit 30 are formed as below.

First, jumper wires 26 are formed by preparing a fourth substrate 23 having a transparent conductive layer on the whole face of the principal face and patterning the transparent conductive layer through etching or the like. The form of the jumper wires 26 is formed similarly to that of the fifth embodiment. Next, a face of the fourth substrate 23 on which the jumper wires 26 are disposed is coated with a liquid transparent resin having hardenability to cover the jumper wires 26 so as to be a flat film, whereby a protection film is formed. Next, at least two through holes reaching up to the jumper wires 26 are formed for each jumper wire 26 at a place, which is located on the face of the protection film, having the jumper wires 26 formed on the lower side thereof. It is preferable that the through holes be formed at both ends of the area located on the jumper wires 26 in a direction in which the jumper wires 26 extend.

Next, a transparent conductive layer is formed on the face of the protection film. From this, the transparent conductive layer is formed also inside the through hole and can be electrically connected to the jumper wire 26. Next, this transparent conductive layer is patterned through etching or the like, whereby driving electrodes 19 and detection electrodes 22 are formed. The driving electrodes 19 and the detection electrodes 22 are formed similarly to that of the fifth embodiment. At this time, it is preferable that the detection electrodes 22 be formed so as to electrically connect the jumper wires 26 adjacent to each other. More specifically, similarly to the fifth embodiment, the detection electrodes 22 and the jumper wires 26 are connected together.

Next, the upper side of the face of the protection film on which the driving electrodes 19 and the detection electrodes 22 are disposed is further coated with a liquid transparent resin having hardenability to embed the unevenness due to the driving electrodes 19 and the detection electrodes 22 so as to be formed as a flat film, whereby a protection layer 27 is formed. Next, an alignment film 17b is formed on the principal face of the protection layer 27. The method of manufacturing this display device is similar to that of the method of manufacturing the display device according to the fifth embodiment other than the description presented above.

<Operation of Display Device>

The operation of this display device is the same as that of the display device according to the first embodiment.

As described above, according to the sixth embodiment, the same advantages as those of the fifth embodiment can be acquired.

<7. Seventh Embodiment>

<Display Device>

FIG. 17 is a cross-sectional view that illustrates the configuration of the vertical cross-section of a pixel (PXL) of a display device 1 according to a seventh embodiment.

As illustrated in FIG. 17, according to this display device 1, in the touch sensor unit 30 of the display device 1 according to the fifth embodiment, the driving electrodes 19 and the detection electrodes 22 are formed in the same layer without using the jumper wires 26.

In the touch sensor unit 30, for example, on a face of the fourth substrate 23 that is located on a side opposite to the light emitting face, driving electrodes 19 and detection electrodes 22 are disposed. The driving electrodes 19 and the detection electrodes 22 are separate from each other and are disposed as a predetermined pattern on the same face in an electrically insulated state. In addition, a protection layer 21 is disposed to cover the whole surface of the driving electrodes 19 and the detection electrodes 22, and accordingly, capacitors are formed between the driving electrodes 19 and the detection electrodes 22.

The configuration of this display device other than the description presented above is the same as that of the display device according to the fifth embodiment.

<Method of Manufacturing Display Device>

The method of manufacturing this display device is the same as the method of manufacturing the display device according to the fifth embodiment except for no formation of the jumper wires 26.

<Operation of Display Device>

The operation of this display device is the same as that of the display device according to the first embodiment.

As described above, according to the seventh embodiment, the same advantages as those of the fifth embodiment can be acquired.

<8. Eighth Embodiment>

<Display Device>

FIG. 18 is a cross-sectional view that illustrates the configuration of the cross-section of a pixel (PXL) of a display device 1 according to an eighth embodiment.

As illustrated in FIG. 18, in this display device 1, as the display switching functioning unit of the display device 1 according to any one of the first to seventh embodiments, the liquid crystal lens unit 20 is replaced by a liquid lens unit 20A.

The liquid lens unit 20A displays an image by passing light emitted from the pixel unit 10 and has a display switching function for displaying an image as a 3D image or a 2D image in a switchable manner. More specifically, the liquid lens unit 20A, for example, includes a polar liquid layer 32 and a non-polar liquid layer 29, which are two liquid layers having mutually-different polarities, between an opposing electrode 16 disposed on the third substrate 15 and a driving electrode 19c disposed on the protection layer 21. The liquid lens unit 20A controls an interface of these two liquid layers having mutually-different polarities using a voltage generated between the driving electrodes 19c disposed to be separate from each other and the opposing electrode 16 so as to be a variable focus lens, thereby realizing the display switching function. In addition, the opposing electrode 16 may be replaced by the pixel common electrode 13a. Accordingly, the liquid lens unit 20A may be replaced by the liquid crystal lens unit 20 of the display device 1 according to any one of the first to seventh embodiments.

A detailed configuration of the liquid lens unit 20A will be described with reference to the drawings. The driving electrode 19c disposed on the protection layer 21 is divided into a plurality of strip patterns. In addition, an insulation layer 28 is disposed to cover the surface of the driving electrodes 19c. The surface of the insulation layer 28 is formed to be flat in parallel with the principal face of the protection layer 21. The surface of the insulation layer 28 is partitioned by a plurality of partition walls 31. As the shape of the partition wall 31, for example, a shape of a face parallel to the principal face of the fourth substrate 23 may be a lattice shape, a strip shape, or the like. The partition walls 31, for example, are disposed at a constant interval in a direction perpendicular to one side of the fourth substrate 23 so as to extend in parallel with one side of the fourth substrate 23, thereby partitioning the surface of the insulation layer 28. In each spatial area partitioned by the partition walls 31, a non-polar liquid layer 29 is maintained. In the spatial area formed by the insulation layer 28 and the opposing electrode 16, a polar liquid layer 32 is maintained in all the area of the spatial area in which the non-polar liquid layer 29 is not maintained. In addition, the area of the insulation layer 28 may be formed by the protection layer 21. At this time, the protection layer 21 is disposed to cover all the driving electrodes 19c.

The shape, the installation form, and the forming material of the driving electrodes 19c are not particularly limited, and those described above as those of the driving electrodes 19 may be appropriately selected. Among them, it is preferable that, as the shape of the driving electrodes 19c, a face parallel to the principal face of the fourth substrate 23 cover at least one partition formed by the partition walls 31. In addition, as the installation form of the driving electrodes 19c, it is preferable that the driving electrodes 19c be disposed at positions covering at least one partition described above on the fourth substrate 23.

The configuration of this display device other than the description presented above is the same as the configuration of any one of the display devices according to the first to seventh embodiments.

<Method of Manufacturing Display Device>

In a method of manufacturing this display device, the formation of the liquid lens unit 20A may be performed using a method in the related art.

The method of manufacturing this display device is similar to that of the method of manufacturing the display device according to any one of the first to seventh embodiments other than the description presented above.

<Operation of Display Device>

In the operation of this display device, a display switching operation will be described.

When light emitted from the pixel unit 10 is incident to the liquid lens unit 20A, in a case where a 3D image is displayed, for example, the polar liquid layer 32 of the liquid lens unit 20A is controlled by applying a 3D display drive signal Vd3 from the control unit 70 or the like illustrated as above to the driving electrodes 19c. From this, the interface between the polar liquid layer 32 and the non-polar liquid layer 29 changes. A 3D image can be displayed by appropriately controlling the liquid interface so as to be a variable lens.

On the other hand, in a case where a 2D image is displayed, for example, the polar liquid layer 32 of the liquid lens unit 20A is controlled by applying a 2D display drive signal Vd4 from the control unit 70 illustrated as above or the like to the driving electrodes 19c. For example, the 2D display drive signal Vd4 is smaller than the 3D display drive signal Vd3. From this, the interface between the polar liquid layer 32 and the non-polar liquid layer 29 changes. A 2D image can be displayed by appropriately controlling the liquid interface so as to be a variable lens.

FIG. 19A illustrates a guided light optical path of light that is incident from the pixel unit 10 to the liquid lens unit 20A and is output from the polarizing plate 24 to the outside at the time of the 3D display. FIG. 19B illustrates a guided light optical path of light that is incident from the pixel unit 10 to the liquid lens unit 20A and is output from the polarizing plate 24 to the outside at the time of the 2D display.

As illustrated in FIG. 19A, for example, when the drive signal Vd3 is applied to the driving electrode 19c, in the liquid lens unit 20A, the interface Si between the polar liquid layer 32 and the non-polar liquid layer 29 is in the shape of a convex lens for the incident light. Accordingly, light incident from the pixel unit 10 side to the liquid lens unit 20A is refracted in the process of passing through the interface S1 and is output in a plurality of mutually-different angular directions. From this, an image that is based on light emitted from the pixel unit 10 is split and is projected into left and right eyes by the liquid lens unit 20A. At this time, in a case where an image that is based on the light emitted from the pixel unit 10 is a composite image of left and right parallax images, the image is displayed as a 3D image and is visually perceived as a 3D image by a person seeing the image.

On the other hand, as illustrated in FIG. 19B, for example, when the drive signal Vd2 is applied to the driving electrode 19a, in the liquid lens unit 20A, a form is formed in which the interface S2 between the polar liquid layer 32 and the non-polar liquid layer 29 is perpendicular to the incident light. Accordingly, the light incident from the pixel unit 10 side to the liquid lens unit 20A is output without being refracted in the interface S2. Accordingly, an image that is based on the light emitted from the pixel unit 10 is displayed as a 2D image on the polarizing plate 24 and is visually perceived as a 2D image by a person seeing this image.

The operation of this display device other than the description presented above is the same as that of the display device according to any one of the first to seventh embodiments.

As described above, according to the eighth embodiment, the same advantages as those of the first to seventh embodiments can be acquired.

<9. Ninth Embodiment>

<Display Device>

FIG. 20 is a cross-sectional view that illustrates the configuration of the cross-section of a pixel (PXL) of a display device 1 according to a ninth embodiment.

As illustrated in FIG. 20, according to this display device 1, the driving electrodes 19d of the liquid lens unit 20A of the display device 1 according to the eighth embodiment are formed to cover the surface of the partition walls 31. At this time, since the partition walls 31 are directly disposed on the surface of the protection layer 21, the insulation layer 28 may not be provided.

The surface of the protection layer 21 is partitioned by a plurality of the partition walls 31. The shape and the installation form of the partition walls 31 may be appropriately selected from among those described above. On the surfaces of the partition walls 31, driving electrodes 19d are disposed to cover the whole surfaces. A material forming the driving electrodes 19d and the like may be appropriately selected from among those of the driving electrode 19 as above. In each spatial area partitioned by the partition walls 31 in which the driving electrodes 19d are disposed, a non-polar liquid layer 29 is maintained. In the spatial area formed by the protection layer 21 and the opposing electrode 16, in all the spatial areas in which the non-polar liquid layer 29 is not maintained, a polar liquid layer 32 is present.

The configuration of the display device other than the above-described configuration is the same as the configuration of the display device according to the eighth embodiment.

<Method of Manufacturing Display Device>

A method of manufacturing this display device is the same as the method of manufacturing the display device according to the eighth embodiment.

<Operation of Display Device>

In the operation of the display device according to the ninth embodiment, a display switching operation will be described.

When light emitted from the pixel unit 10 is incident to the liquid lens unit 20A, in a case where a 3D image is displayed, for example, a 3D display drive signal Vd3 is applied to the driving electrode 19d. When the drive signal Vd3 is applied to the driving electrode 19d, in the liquid lens unit 20A, the interface S1 between the polar liquid layer 32 and the non-polar liquid layer 29 has the shape of a concave lens with respect to the incident light.

The operation of this display device is the same as that of the display device according to the eighth embodiment other than the above-described operation.

As described above, according to the ninth embodiment, the same advantages as those of the eighth embodiment can be acquired.

<10. Tenth Embodiment>

<Display Device>

FIG. 21 is a cross-sectional view that illustrates the configuration of the cross-section of a pixel (PXL) of a display device 1 according to a tenth embodiment.

As illustrated in FIG. 21, according to this display device 1, in the liquid lens unit 20A of the display device 1 according to the eighth embodiment, instead of the partition walls 31 disposed on the surface of the protection layer 21, driving electrodes 19e are disposed. While it is preferable that an insulation film 33 be disposed in a part of the surface that is configured by the protection layer 21 and the driving electrodes 19e, a configuration may be employed in which the insulation film 33 is not disposed on the surface configured by the protection layer 21 and the driving electrodes 19e.

The surface of the protection layer 21 is partitioned by a plurality of the driving electrodes 19e. The shape, the installation form, the constituent material, and the like of the driving electrode 19e may be appropriately selected from among those of the driving electrode 19 described above. In each spatial area partitioned by the driving electrodes 19e having the insulation film 33 on the surface thereof, a non-polar liquid layer 29 is maintained. In the spatial area formed by the insulation film 33 and the opposing electrode 16, in all the spatial areas in which the non-polar liquid layer 29 is not maintained, a polar liquid layer 32 is present.

The configuration of this display device other than the description presented above is the same as the configuration of the display device according to the eighth embodiment.

<Method of Manufacturing Display Device>

A method of manufacturing this display device is the same as the method of manufacturing the display device according to the eighth embodiment.

<Operation of Display Device>

The operation of this display device is the same as that of the display device according to the eighth embodiment. In a case where a configuration is employed in which the insulation film 33 is not disposed on the surface configured by the protection layer 21 and the driving electrodes 19e, the operation of the display device is the same as the operation of the display device according to the ninth embodiment.

As described above, according to the tenth embodiment, the same advantages as those of the eighth embodiment can be acquired.

<11. Eleventh Embodiment>

<Display Device>

FIG. 22 is a cross-sectional view that illustrates the configuration of the cross-section of a pixel (PXL) of a display device 1 according to an eleventh embodiment.

As illustrated in FIG. 22, in this display device 1, as the display switching functioning unit of the display device 1 according to any one of the first to third, fifth, and sixth embodiments, the liquid crystal lens unit 20 is replaced by a liquid crystal barrier unit 20B.

The liquid crystal barrier unit 20B displays an image by passing light emitted from the pixel unit 10 only in a selective area and has a display switching function for displaying the image as a 3D image or a 2D image in a switchable manner. The liquid crystal barrier unit 20B, for example, has a configuration similar to that of the liquid crystal lens unit 20 illustrated as above. More specifically, the liquid crystal barrier unit 20B, for example, has a configuration in which a liquid crystal layer 18a is sealed between opposing electrodes 16 disposed to face each other and driving electrodes 19f, and alignment films 17a and 17b are disposed on the faces facing each other. The pixel unit 10 and the liquid crystal barrier unit 20B are bonded through the polarizing plate 34 and the adhesive layer 14. It is preferable that the pixel unit 10 and the liquid crystal barrier unit 20B be bonded by stacking a second substrate 13, an adhesive layer 14, a polarizing plate 34, and a third substrate 15 in the mentioned order, and the order of the adhesive layer 14 and the polarizing plate 34 in the bonding may be reversed.

While the polarizing plate 34 is not particularly limited, as long as it is used for causing selective polarized light to incident to the liquid crystal layer 18a, it is preferable that the polarizing plate 34 be formed to be thin as possibly as can. For example, as the polarizing plate 34, a polarizing plate that transmits only linearly propagated light may be used.

The driving electrodes 19f disposed on the protection layer 21, for example, extend in parallel with one side of the fourth substrate 23 and are disposed at a constant interval in a direction perpendicular to the one side. The shape, the installation form, the constituent material, and the like of the driving electrodes 19f may be appropriately selected from among those of the driving electrode 19 described above. At this time, an inter-electrode area D1 that is an area between the driving electrodes 19f adjacent to each other constantly transmits light, for example, in the light emitting direction. On the other hand, in an electrode area D2 that is an area in which the driving electrode 19f is disposed, the light transmissivity, for example, in the light emitting direction is configured to be changeable. In other words, in the electrode area D2, by changing the alignment of the liquid crystal in the light emitting direction, switching between light transmission and light blocking is performed. To the liquid crystal layer 18a, selective polarized light is incident in accordance with the polarizing plate 34.

The configuration of this display device other than the description presented above is the same as the configuration of any one of the display devices according to the first to third, fifth, and sixth embodiments.

<Method of Manufacturing Display Device>

A method of manufacturing this display device is the same as the method of manufacturing any one of the display devices according to the first to third, fifth, and sixth embodiments except that the liquid crystal barrier unit 20B is manufactured in the same manner as that of the liquid crystal lens unit 20, and the pixel unit 10 and the liquid crystal barrier unit 20B are bonded through the polarizing plate 34.

<Operation of Display Device>

In the operation of this display device, a display switching operation will be described.

When light emitted from the pixel unit 10 is incident to the liquid crystal barrier unit 20B, in a case where a 3D image is displayed, for example, the liquid crystal layer 18a of the liquid crystal barrier unit 20B is controlled by applying a 3D display drive signal Vd5 from the control unit 70 or the like illustrated as above to the driving electrodes 19f. In this control, a 3D image can be displayed by selectively blocking light emitted from the pixel unit 10.

On the other hand, in a case where a 2D image is displayed, for example, the liquid crystal layer 18a of the liquid crystal barrier unit 20B is controlled by applying a 2D display drive signal V_{d6} from the control unit 70 illustrated as above or the like to the driving electrodes 19d. For example, the 2D display drive signal V_{d6} is smaller than the 3D display drive signal V_{d5}. In this control, a 2D image can be displayed by transmitting the light emitted from the pixel unit 10.

FIG. 23A illustrates a guided light optical path of light that is incident from the pixel unit 10 to the liquid crystal barrier unit 20B and is output from the polarizing plate 34 to the outside at the time of the 3D display. FIG. 23B illustrates a guided light optical path of light that is incident from the pixel unit 10 to the liquid crystal barrier unit 20B and is output from the polarizing plate 34 to the outside at the time of the 2D display.

As illustrated in FIG. 23A, for example, by forming a state in which light emitted from the electrode area D2 is blocked by applying the drive signal V_{d5} to the driving electrode 19f, the emission direction of light emitted from the pixel unit 10 is limited by the inter-electrode area D1 in the liquid crystal barrier unit 20B. From this, similarly to the case of the above-described liquid crystal lens unit 20, in a case where an image that is based on the light emitted from the pixel unit 10 is a composite image of left and right parallax images, the image is split, is projected into left and right eyes, and is visually perceived as a 3D image.

On the other hand, as illustrated in FIG. 23B, for example, by forming a state in which light emitted from the electrode area D2 is transmitted by applying the drive signal V_{d6} to the driving electrode 19f, light incident from the pixel unit 10 is emitted from the liquid crystal barrier unit 20B without limiting the emission direction. From this, similarly to the case of the above-described liquid crystal lens unit 20, an image that is based on the light emitted from the pixel unit 10 is visually perceived as a 2D image.

As described above, according to the eleventh embodiment, the same advantages as those of the first to third, fifth, and sixth embodiments can be acquired.

<12. Twelfth Embodiment>

<Display Device>

FIG. 24 is a cross-sectional view that illustrates the configuration of the cross-section of a pixel (PXL) of a display device 1 according to a twelfth embodiment.

As illustrated in FIG. 24, in this display device 1, the touch sensor unit 30 of any one of the display devices according to the first to eleventh embodiments is configured by a touch sensor unit 30A in which touch sensor driving electrodes 35 independently driving only the touch sensor unit 30 are disposed.

In the touch sensor unit 30A, for example, in the light emitting face of the protection layer 21, the touch sensor driving electrodes 35 are disposed. The touch sensor driving electrodes 35 are disposed to be separate from each other in a predetermined pattern. The touch sensor driving electrodes 35, for example, are disposed to face the driving electrodes 19 through the protection layer 21. The driving electrodes 19 are disposed to be electrically independent from the touch sensor driving electrodes 35 and, for example, drive only the liquid crystal lens unit. Between the touch sensor driving electrodes 35, an insulation layer 36 is disposed. In addition, the detection electrode 22 is disposed on the upper side of the touch sensor driving electrodes 35 through the insulation layer 36. The configuration other than that, for example, may be configured similarly to the seventh embodiment.

While the shape of the touch sensor driving electrode 35 is not particularly limited as long as the touch sensor driving electrode 35 can drive a touch sensor, the same shape as that of the driving electrode 19 may be employed, and a shape may be selected from among the shapes of the driving electrode 19 described above. In addition, while a material forming the touch sensor driving electrode 35 is not particularly limited as long as it has conductivity, a material having high light permeability is preferably used. As the material forming the touch sensor driving electrode 35, the same material as that of the driving electrode 19 may be used, and a material may be appropriately selected from among the materials forming the driving electrode 19 described above.

While the installation form of the touch sensor driving electrodes 35 is not particularly limited as long as it is disposed to be electrically independent from the driving electrodes 19, for example, it is preferable that the touch sensor driving electrodes 35 be disposed on the protection film located on a side opposite to the driving electrodes 19 with respect to the protection layer 21. At this time, the touch sensor driving electrodes 35 may be disposed on the protection layer 21 with the same installation form as that of the driving electrodes 19 employed. In addition, at this time, it is preferable that the touch sensor driving electrodes 35 be disposed at positions symmetrical to the driving electrodes 19 with respect to the protection layer 21.

The configuration of this display device other than the above-described configuration is similar to the configuration of any one of the display devices according to the first to eleventh embodiments.

<Method of Manufacturing Display Device>

The method of manufacturing this display device is the same as the method of manufacturing any one of the display devices according to the first to tenth embodiments except that a touch sensor unit 30A is manufactured by forming a plurality of touch sensor driving electrodes 35 on the protection layer 21 at a constant interval.

<Operation of Display Device>

The operation of this display device is the same as that of the display device according to the first embodiment except that a display switching drive signal V_{d} and a touch sensor drive signal Vₛ are independently applied to the driving electrode 19 and the touch sensor driving electrode 35.

As described above, according to the twelfth embodiment, the same advantages as those of the first to eleventh embodiments can be acquired.

<13. Thirteenth Embodiment>

<Display Device>

FIG. 25 is a cross-sectional view that illustrates the configuration of the cross-section of a pixel (PXL) of a display device 1 according to a thirteenth embodiment.

As illustrated in FIG. 25, in this display device 1, the touch sensor unit 30 of any one of the display devices 1 according to the first to eleventh embodiments is configured as a touch sensor unit 30B in which touch sensor driving electrodes 35 and detection electrodes 22a are formed in the same layer.

In the touch sensor unit 30B, a plurality of the touch sensor driving electrodes 35 and a plurality of detection electrodes 22a are disposed on the protection layer 21 at a constant interval, and an insulation layer 37 is disposed to cover the plurality of the touch sensor driving electrodes 35 and the plurality of the detection electrodes 22a. On the insulation layer 37, a polarizing plate 24 is disposed through a fourth substrate 23. At this time, the insulation layer 37 may be configured by the protection layer 21, and, in such a case, the entire surface of the touch sensor driving electrodes 35 and the detection electrodes 22a are covered with the protection layer 21.

While the shape of the detection electrode 22a is not particularly limited as long as the detection electrode 22a can detect a touch sensor, the same shape as that of the driving electrode 19 may be employed, and a shape may be selected from among the shapes of the driving electrode 19 described above. In addition, while a material forming the detection electrode 22a is not particularly limited as long as it has conductivity, a material having high light permeability is preferably used. As the material forming the detection electrode 22a, the same material as that of the driving electrode 19 may be used, and a material may be appropriately selected from among the materials forming the driving electrode 19 described above.

While the installation form of the detection electrodes 22a is not particularly limited as long as the detection electrodes 22a are disposed on the protection film on a side opposite to the driving electrodes 19 with respect to the protection layer 21, for example, similarly to the installation form of the driving electrodes 19, the detection electrodes 22a may be disposed on the protection layer 21. In such a case, it is preferable that the detection electrodes 22a be disposed at positions symmetrical to the driving electrodes 19 with respect to the protection layer 21. In addition, while the detection electrodes 22a and the touch sensor driving electrodes 35 may be arbitrarily disposed, for example, it is preferable that the detection electrode 22a and the touch sensor driving electrode 35 be alternately arranged.

The configuration of this display device other than the description presented above is the same as the configuration of any one of the display devices according to the first to eleventh embodiments.

<Method of Manufacturing Display Device>

A method of manufacturing this display device is the same as the method of manufacturing the display device according to the twelfth embodiment except that a touch sensor unit 30B is manufactured by forming a plurality of the touch sensor driving electrodes 35 and a plurality of the detection electrodes 22a on the protection layer 21 at a constant interval.

<Operation of Display Device>

The operation of this display device is the same as that of the display device according to the twelfth embodiment.

As described above, according to the thirteenth embodiment, the same advantages as those of the first to eleventh embodiments can be acquired.

<14. Fourteenth Embodiment>

<Electronic Apparatus>

Next, as a fourteenth embodiments, first to fifth examples in which the display device 1 described in the above-described embodiments is applied to electronic apparatuses will be described with reference to FIGS. 26 to 30. For example, the display device can be applied to electronic apparatuses of all the fields such as a television apparatus, a digital camera, a notebook personal computer, a mobile terminal device of a cellular phone, or a video camera. In other words, the display device 1 can be applied to electronic apparatuses of all the fields that display a video signal input from the outside or a video signal generated internally as an image or a video.

FIG. 26 illustrates the outer appearance of a television apparatus that illustrates a first example applied to an electronic apparatus.

As illustrated in FIG. 26, this television apparatus, for example, includes a video display screen unit 300 that includes a front panel 310 and a filter glass 320, and this video display screen unit 510 corresponds to the display device according to the above-described embodiments and the like.

FIG. 27 illustrates the outer appearance of a digital camera that illustrates a second example applied to an electronic apparatus.

As illustrated in FIG. 27, this digital camera, for example, includes a flash light emitting unit 410, a display unit 420, a menu switch 430, and a shutter button 440. The display unit 420 corresponds to the display devices according to the above-described embodiments.

FIG. 28 is a diagram that illustrates the outer appearance of a notebook personal computer illustrating a third example applied to an electronic apparatus. As illustrated in FIG. 28, this notebook personal computer, for example, includes a main frame 510, a keyboard 520 used for an input operation of texts and the like, and a display unit 530 displaying an image, and the display unit 530 corresponds to a display device according to the above-described embodiment or the like.

FIG. 29 illustrates the outer appearance of a video camera illustrating a fourth example applied to an electronic apparatus.

As illustrated in FIG. 29, this video camera, for example, includes a main body unit 610, a lens 620, which is disposed on the front side face of the main body unit 610, used for photographing an object, a start-stop switch 543 used at the time of photographing, and a display unit 630. The display unit 640 corresponds to a display device according to the above-described embodiment or the like.

FIG. 30 illustrates the outer appearance of a cellular phone illustrating a fifth example applied to an electronic apparatus.

As illustrated in FIG. 30, this cellular phone, for example, is acquired by connecting an upper casing 710 and a lower casing 720 using a connection portion (hinge portion) 730 and includes a display 740, a sub-display 750, a picture light 760 and a camera 770. The display 740 or the sub-display 750 corresponds to a display device according to the above-described embodiment or the like.

As above, while the embodiments and the examples have been specifically described, the present disclosure is not limited to the embodiments and the examples described above, and various changes can be made therein based on the technical idea of the present disclosure.

For example, the numeric values, the structures, the configurations, the shapes, the materials, and the like represented in the embodiments and the examples described above are merely examples, and another numeric value, structure, configuration, shape, material, or the like different therefrom may be used as is necessary.

In the above-described embodiments and the like, for example, while the structure is employed in which the display switching functioning unit and the touch sensor unit are disposed on the pixel unit in the mentioned order, the stacking order is not limited thereto, and, for example, it may be configured such that the display switching functioning unit is disposed on the pixel unit through the touch sensor unit. However, it is preferable that the touch sensor unit be stacked on the outermost surface from the viewpoint of the sensor sensitivity.

In addition, in the above-described embodiments and the like, for example, while a stacked structure has been described as an example in which the driving electrode is used to be common to the display switching functioning unit and the touch sensor unit, the structure is not limited thereto, and the driving electrode of each unit may be separately disposed. However, from the viewpoint of a decrease in the thickness and the simplification of the device configuration, it is preferable that the driving electrode be commonly used as in the above-described embodiments and the like.

Furthermore, the present disclosure may take configurations as described below.

(1) There is provided a display device including: a pixel unit; a display switching functioning unit; and a sensor unit, wherein the pixel unit includes a plurality of pixels, the display switching functioning unit is capable of performing switching between a 3D display and a 2D display of an image that is based on light emitted from the pixel unit, the sensor unit detects being in contact with or in proximity to an object, the display switching functioning unit is disposed on the pixel unit in a stacked manner, and the display switching functioning unit includes the sensor unit in the inside.

(2) The display device described in (1) described above, wherein the display switching functioning unit includes a driving electrode, an opposing electrode, and an optical path changing functioning unit, the optical path changing functioning unit is disposed between the driving electrode and the opposing electrode, and the optical path changing functioning unit changes an emission angle and/or an emission area of beams of light in accordance with an applied voltage.

(3) The display device described in (1) or (2) described above, wherein the sensor unit is a capacitive-type touch sensor.

(4) The display device described in any one of (1) to (3) described above, wherein the sensor unit has the driving electrode, a detection electrode, and a protection layer, and the protection layer is disposed between the driving electrode and the detection electrode.

(5) The display device described in any one of (1) to (4) described above, wherein the protection layer is a dielectric.

(6) The display device described in any one of (1) to (5) described above, wherein the driving electrode and the detection electrode are disposed to intersect each other.

(7) The display device described in any one of (1) to (6) described above, wherein the driving electrode is configured by a plurality of driving electrodes having an elongated shape extending in one direction, and the plurality of driving electrodes is disposed in parallel at a constant interval.

(8) The display device described in any one of (1) to (7) described above, wherein the detection electrode is configured by a plurality of detection electrodes having an elongated shape extending in one direction, and the plurality of detection electrodes is disposed in parallel at a constant interval.

(9) The display device described in any one of (1) to (8) described above, wherein the plurality of driving electrodes and the plurality of detection electrodes are disposed to be perpendicular to each other.

(10) The display device described in any one of (1) to (9) described above, wherein the optical path changing functioning unit is a liquid crystal layer or a staked body of a polar liquid layer and a non-polar liquid layer.

(11) The display device described in any one of (1) to (10) described above, wherein the display switching functioning unit is one of a liquid crystal lens, a liquid lens, and a barrier parallax.

(12) The display device described in any one of (1) to (11) described above, wherein the pixel unit includes organic field light emitting devices as the pixels.

(13) The display device described in any one of (1) to (12) described above, wherein the pixel unit includes at least one pixel electrode, at least one organic field light emitting layer, and a pixel common electrode, the organic field light emitting layer is disposed on the pixel electrode, and the pixel common electrode is further stacked on the organic field light emitting layer.

(14) The display device described in any one of (1) to (13) described above, wherein the opposing electrode of the display switching functioning unit is configured as the pixel common electrode.

(15) The display device described in any one of (1) to (14) described above, further including a driving circuit that drives the display switching functioning unit and the sensor unit,
wherein a drive signal is applied from the driving circuit to the driving electrode.

(16) The display device described in any one of (1) to (15) described above, wherein the drive signal is a composite signal in which a drive signal of the sensor unit is superimposed in a drive signal of the display switching functioning unit.

(17) The display device described in any one of (1) to (16) described above, wherein the drive signal of the display switching functioning unit is a 3D display drive signal or a 2D drive signal.

(18) The display device described in any one of (1) to (17) described above, wherein an application time of the sensor unit drive signal is much shorter than an application time of the display switching functioning unit drive signal.

(19) There is provided an electronic apparatus including at least one display device, wherein the display device includes a pixel unit, a display switching functioning unit, and a sensor unit, the pixel unit includes a plurality of pixels, the display switching functioning unit is capable of performing switching between a 3D display and a 2D display of an image that is based on light emitted from the pixel unit, the sensor unit detects being in contact with or in proximity to an object, the display switching functioning unit is disposed on the pixel unit in a stacked manner, and the display switching functioning unit includes the sensor unit in the inside.

Furthermore, the present disclosure may take configurations as described below.

(1)

A display device comprising:
a pixel unit including a first substrate;
a touch sensor unit including a second substrate; and
a liquid crystal layer formed between the pixel unit and the touch sensor unit,
wherein the touch sensor unit includes a detection electrode capacitively coupled with a driving electrode, both the detection electrode and the driving electrode being formed on a side of the touch sensor unit facing the liquid crystal layer.

(2)

The display device according to (1), wherein the detection electrode is formed on a side of the second substrate away from the liquid crystal layer, and the driving electrode is formed on a side of the second substrate toward the liquid crystal layer.

(3)

The display device according to (1), wherein the detection electrode and the driving electrode are both formed on a side of the second substrate toward the liquid crystal layer.

(4)

The display device according to (1), wherein the pixel unit further includes a plurality of organic EL devices that are display pixels.

(5)

The display device according to (1), wherein the pixel unit further includes at least one pixel electrode layer and at least one organic EL layer stacked on the first substrate, and a pixel common electrode is further stacked on the organic EL layer.

(6)

The display device according to (1), wherein the pixel unit further includes an opposing electrode disposed on a side of the second substrate facing the liquid crystal layer.

(7)

The display device according to (6), wherein the pixel unit further includes a third substrate, and the opposing electrode is formed on a face of the third substrate.

(8)

The display device according to (6), wherein the opposing electrode is configured to apply a driving voltage to the liquid crystal layer and/or the touch sensor unit in combination with the driving electrode.

(9)

The display device according to (1), wherein the driving electrode and the detection electrode are separated by the second substrate or a protection layer formed therebetween.

(10)

The display device according to (1), wherein the detection electrode includes portions extending in a first direction, and the driving electrode includes portions extending in a second direction that intersects with the first direction.

(11)

The display device according to (1), further comprising a driving circuit, wherein the driving circuit is configured to apply a drive signal from the driving circuit for the touch sensor unit together with a drive signal from the driving circuit for the liquid crystal lens unit in an overlapping manner.

(12)

The display device according to (1), wherein the pixel unit further includes an opposing electrode and a pixel common electrode, and the first substrate is formed directly between the opposing electrode and the pixel common electrode.

(13)

An electronic apparatus comprising:
a control unit;
display device operable to receive control signals from the control unit, the display device including:
a pixel unit including a first substrate,
a touch sensor unit including a second substrate, and
a liquid crystal layer formed between the pixel unit and the touch sensor unit,
wherein the touch sensor unit includes a detection electrode capacitively coupled with a driving electrode, both the detection electrode and the driving electrode being formed on a side of the touch sensor unit facing the liquid crystal layer.

(14)

The electronic apparatus according to (13), wherein the detection electrode is formed on a side of the second substrate away from the liquid crystal layer, and the driving electrode is formed on a side of the second substrate toward the liquid crystal layer.

(15)

The electronic apparatus according to (13), wherein the detection electrode and the driving electrode are both formed on a side of the second substrate toward the liquid crystal layer.

(16)

The electronic apparatus according to (13), wherein the pixel unit further includes a plurality of organic EL devices that are display pixels.

(17)

The electronic apparatus according to (13), wherein the pixel unit further includes at least one pixel electrode layer and at least one organic EL layer stacked on the first substrate, and a pixel common electrode is further stacked on the organic EL layer.

(18)

The electronic apparatus according to (13), wherein the pixel unit further includes an opposing electrode disposed on a side of the second substrate facing the liquid crystal layer.

(19)

The electronic apparatus according to (18), wherein the pixel unit further includes a third substrate, and the opposing electrode is formed on a face of the third substrate.

(20)

The electronic apparatus according to (18), wherein the opposing electrode is configured to apply a driving voltage to the liquid crystal layer and/or the touch sensor unit in combination with the driving electrode.

(21)

The electronic apparatus according to (13), wherein the driving electrode and the detection electrode are separated by the second substrate or a protection layer formed therebetween.

(22)

The electronic apparatus according to (13), wherein the detection electrode includes portions extending in a first direction, and the driving electrode includes portions extending in a second direction that intersects with the first direction.

(23)

The electronic apparatus according to (13), further comprising a driving circuit, wherein the driving circuit is configured to apply a drive signal from the driving circuit for the touch sensor unit together with a drive signal from the driving circuit for the liquid crystal lens unit in an overlapping manner.

(24)

The electronic apparatus according to (13), wherein the pixel unit further includes an opposing electrode and a pixel common electrode, and the first substrate is formed directly between the opposing electrode and the pixel common electrode.

It should be understood by those skilled in the art that various modifications, combinations, sub-combinations and alterations may occur depending on design requirements and other factors insofar as they are within the scope of the appended claims or the equivalents thereof.

The present disclosure contains subject matter related to that disclosed in Japanese

Priority Patent Application JP 2012-193708 filed in the Japan Patent Office on Sep. 4, 2012, the entire content of which is hereby incorporated by reference.

### REFERENCE SIGNS LIST

1 Display device
10 Pixel unit
11 First substrate
11 a Pixel electrode layer
12 Organic EL layer
13 Second substrate
13a Pixel common electrode
14 Adhesive layer
15 Third substrate
16 Opposing electrode
17a, 17b Alignment film
18 Liquid crystal layer
19 Driving electrode
20 Liquid crystal lens unit
20A Liquid lens unit
20B Liquid crystal barrier unit
21 Protection layer
22 Detection electrode
23 Fourth substrate
24 Polarizing plate

1. A display device comprising:
a pixel unit including a first substrate;
a touch sensor unit including a second substrate; and
a liquid crystal layer formed between the pixel unit and the touch sensor unit,
wherein the touch sensor unit includes a detection electrode capacitively coupled with a driving electrode, both the detection electrode and the driving electrode being formed on a side of the touch sensor unit facing the liquid crystal layer.

2. The display device according to claim 1, wherein the detection electrode is formed on a side of the second substrate away from the liquid crystal layer, and the driving electrode is formed on a side of the second substrate toward the liquid crystal layer.

3. The display device according to claim 1, wherein the detection electrode and the driving electrode are both formed on a side of the second substrate toward the liquid crystal layer.

4. The display device according to claim 1, wherein the pixel unit further includes a plurality of organic EL devices that are display pixels.

5. The display device according to claim 1, wherein the pixel unit further includes at least one pixel electrode layer and at least one organic EL layer stacked on the first substrate, and a pixel common electrode is further stacked on the organic EL layer.

6. The display device according to claim 1, wherein the pixel unit further includes an opposing electrode disposed on a side of the second substrate facing the liquid crystal layer.

7. The display device according to claim 6, wherein the pixel unit further includes a third substrate, and the opposing electrode is formed on a face of the third substrate.

8. The display device according to claim 6, wherein the opposing electrode is configured to apply a driving voltage to the liquid crystal layer and/or the touch sensor unit in combination with the driving electrode.

9. The display device according to claim 1, wherein the driving electrode and the detection electrode are separated by the second substrate or a protection layer formed therebetween.

10. The display device according to claim 1, wherein the detection electrode includes portions extending in a first direction, and the driving electrode includes portions extending in a second direction that intersects with the first direction.

11. The display device according to claim 1, further comprising a driving circuit, wherein the driving circuit is configured to apply a drive signal from the driving circuit for the touch sensor unit together with a drive signal from the driving circuit for the liquid crystal lens unit in an overlapping manner.

12. The display device according to claim 1, wherein the pixel unit further includes an opposing electrode and a pixel common electrode, and the first substrate is formed directly between the opposing electrode and the pixel common electrode.

13. An electronic apparatus comprising:
a control unit;
display device operable to receive control signals from the control unit, the display device including:
a pixel unit including a first substrate,
a touch sensor unit including a second substrate, and
a liquid crystal layer formed between the pixel unit and the touch sensor unit,
wherein the touch sensor unit includes a detection electrode capacitively coupled with a driving electrode, both the detection electrode and the driving electrode being formed on a side of the touch sensor unit facing the liquid crystal layer.

14. The electronic apparatus according to claim 13, wherein the detection electrode is formed on a side of the second substrate away from the liquid crystal layer, and the driving electrode is formed on a side of the second substrate toward the liquid crystal layer.

15. The electronic apparatus according to claim 13, wherein the detection electrode and the driving electrode are both formed on a side of the second substrate toward the liquid crystal layer.

16. The electronic apparatus according to claim 13, wherein the pixel unit further includes a plurality of organic EL devices that are display pixels.

17. The electronic apparatus according to claim 13, wherein the pixel unit further includes at least one pixel electrode layer and at least one organic EL layer stacked on the first substrate, and a pixel common electrode is further stacked on the organic EL layer.

18. The electronic apparatus according to claim 13, wherein the pixel unit further includes an opposing electrode disposed on a side of the second substrate facing the liquid crystal layer.

19. The electronic apparatus according to claim 18, wherein the pixel unit further includes a third substrate, and the opposing electrode is formed on a face of the third substrate.

20. The electronic apparatus according to claim 18, wherein the opposing electrode is configured to apply a driving voltage to the liquid crystal layer and/or the touch sensor unit in combination with the driving electrode.

21. The electronic apparatus according to claim 13, wherein the driving electrode and the detection electrode are separated by the second substrate or a protection layer formed therebetween.

22. The electronic apparatus according to claim 13, wherein the detection electrode includes portions extending in a first direction, and the driving electrode includes portions extending in a second direction that intersects with the first direction.

23. The electronic apparatus according to claim 13, further comprising a driving circuit, wherein the driving circuit is configured to apply a drive signal from the driving circuit for the touch sensor unit together with a drive signal from the driving circuit for the liquid crystal lens unit in an overlapping manner.

24. The electronic apparatus according to claim 13, wherein the pixel unit further includes an opposing electrode and a pixel common electrode, and the first substrate is formed directly between the opposing electrode and the pixel common electrode.
